(19) United States
(12) Patent Application Publication
(10) Pub. No.: US 2015/0116421 A1
(43) Pub. Date: Apr. 30, 2015

(54) INKJET RECORDING INK, INK CARTRIDGE USING THE INK, AND INKJET RECORDING DEVICE USING THE INK

(71) Applicants: Masayasu NONOGAKI, Shizuoka (JP); Mitsuru NARUSE, Shizuoka (JP); Akihiko MATSUYAMA, Shizuoka (JP); Keita KATOH, Shizuoka (JP); Kazukiyo NAGAI, Shizuoka (JP); Yuusuke KOIZUKA, Shizuoka (JP); Nobuyuki SAKAMOTO, Ibaraki (JP); Yosuke MATSUOKA, Ibaraki (JP); Masatomo TAKAHASHI, Ibaraki (JP)

(72) Inventors: Masayasu NONOGAKI, Shizuoka (JP); Mitsuru NARUSE, Shizuoka (JP); Akihiko MATSUYAMA, Shizuoka (JP); Keita KATOH, Shizuoka (JP); Kazukiyo NAGAI, Shizuoka (JP); Yuusuke KOIZUKA, Shizuoka (JP); Nobuyuki SAKAMOTO, Ibaraki (JP); Yosuke MATSUOKA, Ibaraki (JP); Masatomo TAKAHASHI, Ibaraki (JP)

(21) Appl. No.: 14/524,189

(22) Filed: Oct. 27, 2014

(30) Foreign Application Priority Data
Oct. 31, 2013 (JP) 2013-226905

(51) Int. Cl. C09D 11/322; C08K 3/04; C08K 5/23; C09D 11/326; C09D 133/14

(52) U.S. Cl. CPC C09D 11/322; C09D 11/326; C09D 133/14; C08K 5/235; C08K 3/04
USPC 347/20; 524/378; 524/190; 347/86

(57) ABSTRACT

An inkjet recording ink, including: water; a water-soluble solvent; a pigment; and a phosphoric acid group-containing copolymer,
wherein the phosphoric acid group-containing copolymer contains at least a structural unit represented by General Formula (1) and a structural unit represented by General Formula (2):

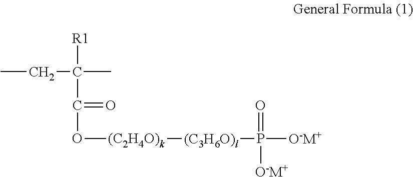

where in General Formula (1), R1 represents a hydrogen atom or a methyl group, M⁺ represents a proton, an alkali metal ion, or an organic ammonium ion, k and l are each an integer of 0 to 6, with the proviso that the case where k and l are 0 at the same time is excluded,

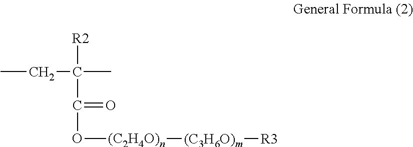

where in General Formula (2), R2 represents a hydrogen atom or a methyl group, R3 represents an alkyl group having 1 to 4 carbon atoms, n and m are each an integer of 0 to 30, with the proviso that n+m is 2 to 30.

### BACKGROUND OF THE INVENTION

1. Field of the Invention

The present invention relates to an inkjet recording ink, an ink cartridge using the ink, and an inkjet recording device using the ink.

2. Description of the Related Art

In recent years, inkjet recording methods have become popular as an image forming method since the inkjet recording methods have advantages that they can be performed in accordance with easier processes than other recording methods and be simply allowed to form full color images, and can form high-definition images even with devices having simple configurations.

Such inkjet recording methods are methods including: jetting a small amount of ink by pressure generated utilizing, for example, bubbles generated by heat, piezoelectric force, or electrostatic force to be attached onto recording media such as paper; and rapidly drying the ink on the recording media or allowing the ink to penetrate into the recording media to form an image. The inkjet recording methods have seen applications extended to personal and industrial printers and printing.

Inkjet recording devices mainly use aqueous ink using an aqueous dye as a pigment, but the dye ink has disadvantages of being poor in weatherability and waterproofness. Hence, studies have recently been made on pigment ink using a pigment instead of a water-soluble dye. However, the pigment ink is still inferior to the dye ink in color developability, ejection stability of the ink, and storage stability.

Meanwhile, with the improvement in technologies of increasing image quality for OA printers, the pigment ink has also been required to exhibit comparable image density to that of the dye ink on plain paper serving as a recording medium. However, when plain paper is used as recording media, the pigment ink penetrates into the paper, resulting in lowered pigment concentration on the paper surface and hence in lowered image density, which is problematic.

Also, the recent increased demands for inkjet recording inks especially as industrial applications are expecting printing processes at higher speed. With the increased printing speed, inkjet printers with line heads mounted therein have been proposed. In order to increase the drying speed of ink attached onto recording media to attain high-speed printing, one measure that is taken is to quicken drying by adding a penetrating agent to ink for water to penetrate into recording media. At this time, however, not only water but also pigment increases disadvantageously in penetratability into recording media, leading to a phenomenon where image density further decreases.

Various methods have been proposed for improving image density.

For example, Japanese Patent Application Laid-Open (JP-A) No. 2011-122072 discloses an ink used for recording on paper containing a water-soluble polyvalent metal salt. This ink contains (a) a pigment, and (b) at least one compound having no surface activating ability, having a molecular weight of 150 to 10,000, and having a phosphorus content of 1.4 or greater which is the content of phosphorus in its molecular structure (the P content/the molecular weight×100) where the phosphorus is derived from a functional group selected from a functional group having phosphoric acid as a basic skeleton thereof and a functional group having phosphoric acid as a basic skeleton thereof, wherein the content (% by mass) of the compound defined in (b) is 1.5% by mass to 10.0% by mass based on the total mass of the ink.

Also, JP-A No. 2009-197211 discloses a pigment ink containing a copolymer of a monomer having an oxyalkylene chain and another monomer, a pigment, and an aqueous solvent, disclosing polyethylene glycol (meth)acrylate, methoxy polyethylene glycol (meth)acrylate, and the like as the monomer having an oxyalkylene chain and disclosing anionic monomers serving as the another monomer such as phosphoric acid-based monomers methacryloxyethyl phosphate, diphenyl-2-acryloxyethyl phosphate.

However, JP-A No. 2009-197211 neither exemplifies combinations of General Formula (1) and General Formula (2) in the present invention, nor shows any effects of combinations of the monomer having an oxyalkylene chain and the phosphoric acid-based monomer.

The method of JP-A No. 2011-122072 was insufficient in improvement of image density on plain paper containing a water-soluble polyvalent metal salt in a small amount. Also, use of a compound having a functional group selected from a functional group having phosphoric acid as a basic skeleton thereof and a functional group having phosphonic acid as a basic skeleton thereof was found to improve image density but instabilize dispersion of a pigment in an ink.

That is, the method of JP-A No. 2011-122072 cannot achieve high image density and dispersion stability of a pigment in an ink at the same time.

### SUMMARY OF THE INVENTION

The present invention aims to provide an inkjet recording ink which can achieve high image density even on plain paper, is excellent in terms of dispersion stability of a pigment in the ink, and is excellent in terms of ejection stability of the ink.

An inkjet recording ink of the present invention as a means for solving the above problems includes: water; a water-soluble solvent; a pigment; and a phosphoric acid group-containing copolymer,

wherein the phosphoric acid group-containing copolymer contains at least a structural unit represented by the following General Formula (1) and a structural unit represented by the following General Formula (2):

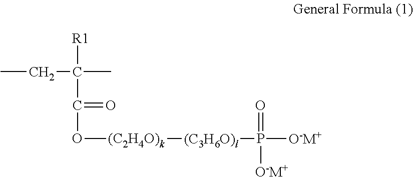

where in General Formula (1), R1 represents a hydrogen atom or a methyl group, M⁺ represents a proton, an alkali metal ion, or an organic ammonium ion, k and l are each an integer of 0 to 6, with the proviso that the case where k and l are 0 at the same time is excluded,

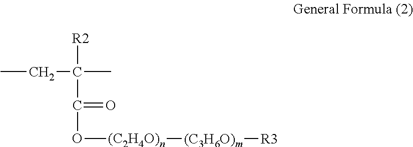

where in General Formula (2), R2 represents a hydrogen atom or a methyl group, R3 represents an alkyl group having 1 to 4 carbon atoms, n and m are each an integer of 0 to 30, with the proviso that n+m is 2 to 30.

The present invention can provide an inkjet recording ink which can achieve high image density even on plain paper, is excellent in terms of dipersion stability of a pigment in the ink, and is excellent in terms of ejection stability of the ink. This ink can solve the above existing problems and achieve the above object.

### BRIEF DESCRIPTION OF THE DRAWINGS

FIG. 1 is a schematic plan diagram illustrating one example of an ink cartridge of the present invention.

FIG. 2 is a schematic plan diagram illustrating the ink cartridge of the present invention illustrated in FIG. 1 and a case (exterior) thereof.

FIG. 3 is a perspective diagram illustrating one example of a serial type inkjet recording device of the present invention.

FIG. 4 is a partially enlarged cross-sectional diagram of the inkjet recording device illustrated in FIG. 3.

FIG. 5 is another partially enlarged cross-sectional diagram of the inkjet recording device illustrated in FIG. 3.

### DETAILED DESCRIPTION OF THE INVENTION

### (Inkjet Recording Ink)

An inkjet recording ink of the present invention includes water, a water-soluble solvent, a pigment, and a phosphoric acid group-containing copolymer. The copolymer includes a structural unit represented by the following General Formula (1) and a structural unit represented by the following General Formula (2):

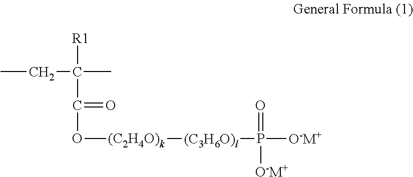

where in General Formula (1), R1 represents a hydrogen atom or a methyl group; M⁺ represents a proton, an alkali metal ion, or an organic ammonium ion; and k and l are each an integer of 0 to 6, with the proviso that the case where k and l are 0 at the same time is excluded,

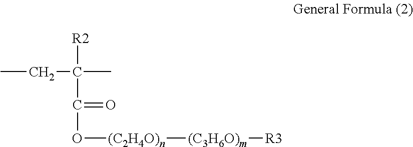

where in General Formula (2), R2 represents a hydrogen atom or a methyl group; R3 represents an alkyl group having 1 to 4 carbon atoms; and n and m are each an integer of 0 to 30, with the proviso that n+m is 2 to 30.

The structural unit represented by the General Formula (1) is characterized by exhibiting hydrophilicity, but exhibiting hydrophobicity in a state of being bound to a polyvalent metal ion (in particular, a calcium ion). Accordingly, in the case where an ink which contains a compound having a structural unit represented by the General Formula (1) is used to form an image on printing paper containing a water-soluble polyvalent metal salt, the structural unit represented by the General Formula (1) is hydrophobized by the action of a polyvalent metal ion eluted from the paper to the ink to thereby form an aggregate with a pigment. As a result, the pigment remains on a surface of the paper, leading to an improved image density.

However, in the case of plain paper, a polyvalent metal salt contained in the paper is generally a water-insoluble calcium carbonate, so that only a small amount of calcium ions are eluted into the ink. Therefore, the structural unit represented by the General Formula (1) is not enough to achieve satisfactory image density in plain paper.

As a means for solving the above problem, there has been proposed that a compositional rate of the structural unit represented by the General Formula (1) is increased in the phosphate group-containing copolymer. However, when the compositional rate of the General Formula (1) is increased, the copolymer is formed into a gel, leading to a deteriorated storage stability of the ink. This is probably because an interaction between phosphate groups is enhanced. Therefore, conventionally, in the case where a phosphate group-containing copolymer was used, a compositional rate of the structural unit represented by the General Formula (1) in a phosphate group-containing copolymer had to be less than 20% by mass.

In the present invention, when the structural unit represented by the General Formula (1) is used in combination with the structural unit represented by the General Formula (2), the affinity with the pigment and an effect of forming the aggregation with the pigment are improved. Storage stability is also improved even in an ink containing a large amount of a water-soluble solvent.

Additionally, a copolymer is less likely to be formed into a gel. As a result, the compositional rate of the structural unit represented by the General Formula (1) can be increased, and reactivity with the polyvalent metal ion (in particular, a calcium ion) can be improved.

Thus, an ink of the present invention can achieve high image density even in common plain paper which contains a small amount of a polyvalent water-soluble metal salt.

Next, the inkjet recording ink, the ink cartridge, and the production method of the inkjet recorded matter, and the inkjet recording device, and the inkjet recorded matter according to the present invention, each of which uses the ink, are described in more detail.

Because embodiments described below are suitable embodiments of the present invention, they have technically preferable various limitations. However, a range of the present invention is not limited to these aspects as long as mention limited to the present invention is not described as follows.

### <Inkjet Recording Ink>

An inkjet recording ink (hereinafter may be referred to as “ink”) of the present embodiment includes water, a water-soluble solvent, a pigment, and a copolymer which is reacted with polyvalent metal ions (in particular, calcium ions) in plain paper to cause aggregation; and includes, if necessary, other ingredients.

When the copolymer of the inkjet recording ink according to the present invention is impacted onto a recording medium such as plain paper, polyvalent metal ions in plain paper are reacted with the copolymer to cause aggregation. As a result, the ink is inhibited from penetrating into paper to thereby achieve high image density.

As described above, the copolymer which is reacted with polyvalent metal ions to cause aggregation is a polymer which includes a structural unit represented by the General Formula (1) and a structural unit represented by the General Formula (2).

The materials constituting the inkjet recording ink of the present invention is described in more detail hereinafter.

### (Phosphoric Acid Group-Containing Copolymer)

The phosphoric acid group-containing copolymer used in the present invention has a property that is reacted with polyvalent metal ions (in particular, calcium ions) in plain paper to cause aggregation at a time when the inkjet recording ink is impacted onto a recording medium such as plain paper. Owing to this function, the ink is inhibited from penetrating into paper to thereby achieve high image density.

In the present invention, the phosphoric acid group-containing copolymer may be used as a dispersing agent or an additive. In particular, use of the copolymer as the dispersing agent can provide an ink that achieves high image density and is good in storage stability and ejection stability.

In the General Formula (1), R1 represents a hydrogen atom or a methyl group. In the General Formula (1), M⁺ represents a proton, an alkali metal ion, or an organic ammonium ion; and is preferably neutralized with a base to thereby be ionized.

Examples of the base to be used for neutralization include inorganic alkalis such as alkali metal hydroxides (e.g., lithium hydroxide, sodium hydroxide, and potassium hydroxide); alkyl amines such as mono-, di-, or tri-methylamine, and mono-, di-, or tri-ethylamine; alcohol amines such as ethanolamine, diethanolamine, triethanolamine, methylethanolamine, methyldiethanolamine, dimethylethanolamine, monopropanolamine, dipropanolamine, tripropanolamine, isopropanolamine, trishydroxymethylaminomethane, 2-amino-2-ethyl-1,3-propanediol (AEPD); cyclic amines such as choline, morpholine, N-methyl morpholine, N-methyl-2-pyrrolidone, and 2-pyrrolidone; and organic ammonium hydroxides such as tetramethylammonium hydroxide, tetraethylammonium hydroxide, and tetrabutylammonium hydroxide.

Among them, organic amines such as ethanol amine and dimethylethanolamine are preferable from the viewpoints of storage stability and ejection stability of the ink.

Half or more of the M⁺ in the copolymer are preferably neutralized with bases to thereby be ionized. In particular, all of the M⁺ in the copolymer are preferably neutralized with bases to thereby be ionized from the viewpoints of image density, storage stability, and ejection stability.

In the present invention, the neutralization rate of a phosphoric acid group-containing copolymer obtained through neutralization treatment is defined as a value determined according to the following method.

When the compound represented by the General Formula (3) is assumed to be Monomer 1, the following equation is satisfied:

Neutralization rate X(%)=(Number of moles of Base to be added×Valence of cations of Base)/(Number of moles of Monomer 1 contained in copolymer×2)×100

where Number of moles of Base to be added=Amount of Base to be added Yg/Molecular weight of Base, and

Number of moles of Monomer 1 contained in copolymer=Amount of Monomer 1 to be charged Zg/Molecular weight of Monomer 1.

Accordingly, an amount of a base which is required to achieve the neutralization rate X (%) is expressed as the following equation:

Amount of Base to be added Yg=Neutralization rate X(%)×(Amount of Monomer 1 to be charged×2)×Molecular weight of Base/(Valence of cations of Base×100×Molecular weight of Monomer 1).

In addition to the structural unit represented by the General Formula (1) and the structural unit represented by the General Formula (2), the phosphoric acid group-containing copolymer includes a structural unit originated from other monomers.

The other monomers are particularly limited and may be appropriately selected depending on the intended purpose. Examples thereof include a polymerizable hydrophobic monomer and a polymerizable hydrophilic monomer.

The polymerizable hydrophobic monomer is not particularly limited and may be appropriately selected depending on the intended purpose. Examples thereof include unsaturated ethylene monomers having an aromatic ring such as styrene, α-methylstyrene, 4-t-butylstyrene, and 4-chloromethylstyrene; (meth)acrylic acid alkyls such as (meth)acrylic acid methyl, (meth)acrylic acid ethyl, (meth)acrylic acid n-butyl, maleic acid dimethyl, itaconic acid dimethyl, fumaric acid dimethyl, (meth)acrylic acid lauryl (C12), (meth)acrylic acid tridecyl (C13), (meth)acrylic acid tetradecyl (C14), (meth)acrylic acid pentadecyl (C15), (meth)acrylic acid hexadecyl (C16), (meth)acrylic acid heptadecyl (C17), (meth)acrylic acid nonadecyl (C19), (meth)acrylic acid eicosyl (C20), (meth)acrylic acid henicosyl (C21), and (meth)acrylic acid docosyl (C22); and unsaturated ethylene monomers having an alkyl group such as 1-heptene, 3,3-dimethyl-1-pentene, 4,4-dimethyl-1-pentene, 3-methyl-1-hexene, 4-methyl-1-hexene, 5-methyl-1-hexene, 1-octene, 3,3-dimethyl-1-hexene, 3,4-dimethyl-1-hexene, 4,4-dimethyl-1-hexene, 1-nonene, 3,5,5-trimethyl-1-hexene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, and 1-docosene. These may be used alone or in combination.

The polymerizable hydrophilic monomer is not particularly limited and may be appropriately selected depending on the intended purpose. Examples thereof include anionic unsaturated ethylene monomers such as (meth)acrylic acid or salt thereof, maleic acid or salt thereof, maleic acid monomethyl, itaconic acid, itaconic acid monomethyl, fumaric acid, 4-styrenesulfonic acid, and 2-acrylamide-2-methylpropane sulfonic acid; and nonionic unsaturated ethylene monomers such as (meth)acrylic acid-2-hydroxyethyl, diethylene glycolmono(meth)acrylate, triethylene glycolmono(meth)acrylate, tetraethylene glycolmono(meth)acrylate, polyethylene glycolmono(meth)acrylate, (meth)acrylamide, N-methylol(meth)acrylamide, N-vinylformamide, N-vinylacetamide, N-vinylpyrrolidone, acrylamide, N,N-dimethyl acrylamide, N-t-butylacrylamide, N-octylacrylamide, and N-t-octylacrylamide. These may be used alone or in combination.

A polymerization method of a phosphoric acid group-containing copolymer used in the present invention is not particularly limited and the known polymerization method may be used.

In one exemplary method, a 4-neck flask equipped with a thermometer, a stirrer, and a nitrogen-inducing pipe is charged with a solvent, a monomer represented by the following General Formula (3), and a monomer represented by the following General Formula (4). If necessary, a polymerization initiator and a chain transfer agent may be charged into the resultant mixture. The resultant mixture is allowed to undergo polymerization at a normal temperature to 150° C. A viscosity of phosphoric acid group-containing copolymer can be adjusted by changing molecular weight thereof and concentration of the monomer upon polymerization, the amount of polymerization initiator, temperature of polymerization, and polymerization time may be changed.

Examples of the synthesis method employable include known various synthetic methods such as a solution polymerization, a suspension polymerization, a block polymerization, and an emulsion polymerization. A radical polymerization initiator may be preferably used because the polymerization operation and adjusting a molecular weight are easy.

The radical polymerization initiator may be generally used radical polymerization initiators. Specific examples thereof include peroxy ketal, hydroperoxide, dialkyl peroxide, diacyl peroxide, peroxy dicarbonate, peroxy ester, cyano-based azobisisobutyronitrile, azobis(2-methylbutyronitrile), and azobis(2,2′-isovaleronitrile), and non-cyano-based dimethyl-2,2′-azobisisobutylate.

Preferable are organic peroxides and azo-based compounds which are easy to control a molecular weight and have low decomposition temperature. In particular, azo-based compounds are more preferable. An amount of the polymerization initiator used is preferably 1% by mass to 10% by mass relative to a total mass of a polymerizable monomer.

In order to adjust the molecular weight of the phosphoric acid group-containing copolymer, a proper quantity of the chain transfer agent such as mercaptoacetic acid, mercaptopropionic acid, 2-propanethiol, 2-mercaptoethanol, thiophenol, dodecyl mercaptan, 1-dodecanthiol, and thioglycerol may be added to the polymerized system.

The polymerization temperature is preferably 50° C. to 150° C. and the polymerization time is preferably 3 hours to 48 hours.

The phosphoric acid group-containing copolymer in the present invention is synthesized from starting materials including at least two kinds of monomers which are a monomer represented by the following General Formula (3) and a monomer represented by the following General Formula (4). Phosphate groups in the copolymer are preferably partially or wholly neutralized with bases selected from alkali metals or organic amines.

Examples of the method for adding the neutralizer include a method in which the phosphoric acid group-containing copolymer obtained by the above production method and the neutralizer are mixed in a solution. The phosphoric acid group-containing copolymer is dissolved in water or a solvent. Then, the neutralizer is directly added to the resultant solution; or a solution of the neutralizer dissolved in water or an organic solvent is added to the resultant solution to stir. The phosphoric acid group-containing copolymer neutralized with bases can be obtained by removing the solvent.

After termination of the polymerization reaction, the phosphoric acid group-containing copolymer obtained can be isolated by means of known methods such as reprecipitation and removing the solvent from the resultant solution. By means of repeating reprecipitation, membrane separation, chromatographs, and extraction method, unreacted monomers and low molecular weight components are removed and the phosphoric acid group-containing copolymer can be purified.

Note, in the present invention, that phosphorus groups neutralized partially or wholly in copolymer are referred to as “the phosphoric acid group-containing copolymer”.

The phosphoric acid group-containing copolymer in the present invention is synthesized from starting materials including at least two kinds of monomers which are a monomer represented by the following General Formula (3) and a monomer represented by the following General Formula (4):

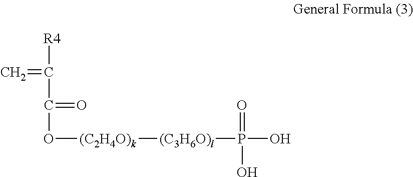

where in Formula (3), R4 represents a hydrogen atom or a methyl group, k and l are each an integer of 0 to 6, with the proviso that the case where k and l are 0 at the same time is excluded,

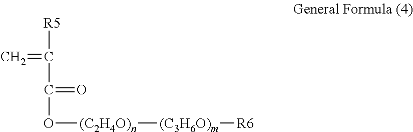

where in Formula (4), R5 represents a hydrogen atom or a methyl group, R6 represents an alkyl group having 1 to 4 carbon atoms, and n and m are each an integer of 0 to 30, with the proviso that n+m is 2 to 30.

Examples of the monomer represented by the Formula (3) include monomers represented by the following (Formula 3-1) to (Formula 3-4).

In the structural unit represented by the General Formula (1) in the copolymer, preferably k is l and l is 0. Examples of the monomer represented by the Formula (3) preferably include monomers represented by the following (Formula 3-1) and (Formula 3-2).

Examples of the monomer represented by the General Formula (4) include the following (Formula 4-1) to (Formula 4-7).

In the structural unit represented by the General Formula (2) in the copolymer, preferably n is 9 and m is 0. Examples of the monomer represented by the Formula (4) preferably include monomers represented by (Formula 4-1) and (Formula 4-2).

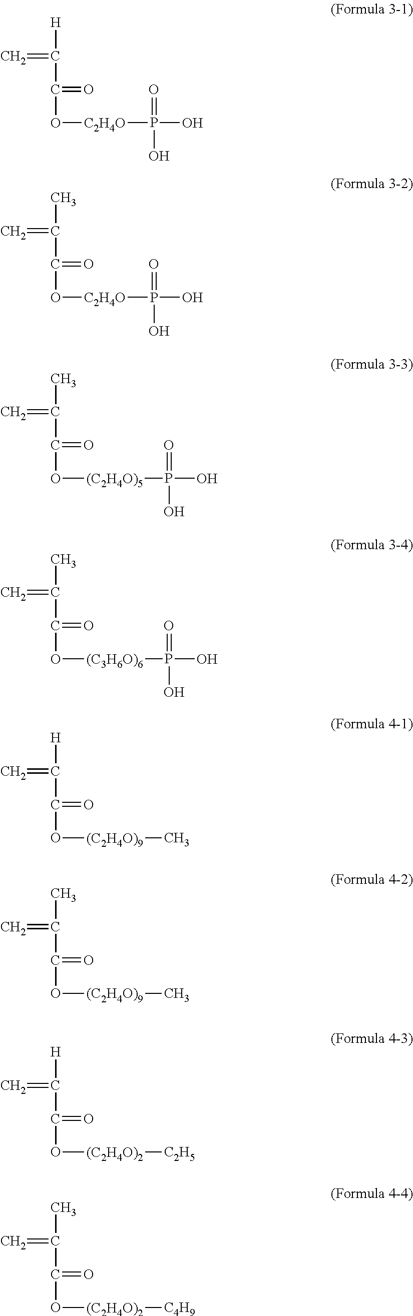

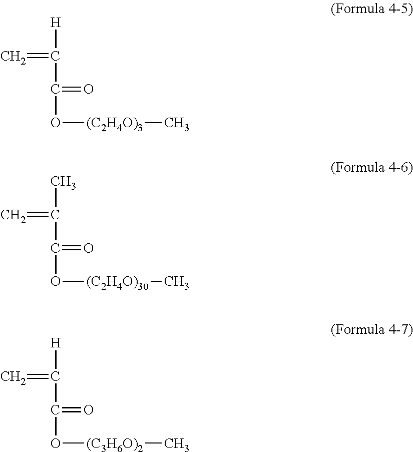

In the phosphoric acid group-containing copolymer of the present invention, when the amount of the structural unit represented by the General Formula (1) is low, reactivity with calcium ions eluted from a recording medium is declined and image density is tend to be declined.

In this point, the above the amount thereof is preferably 10% by mass to 60% by mass, and more preferably 10% by mass to 50% by mass. When the above amount thereof is 60% by mass or less, dispersion stability of the pigment is improved and viscosity of the ink is stable to thereby achieve good storage stability and ejection stability. That is, because the above amount thereof is 10% by mass to 60% by mass, improvement of image density, dispersion stability of the pigment in the ink, and ejection stability at a printing time can be compatible at a high level.

A viscosity (25° C.) of an aqueous solution of the phosphoric acid group-containing copolymer having a solid content of 10% by mass in the present invention is preferably 2.0 mPa·s to 30.0 mPa·s, and is more preferably 2.5 mPa·s to 27.0 mPa·s. When the viscosity is 2.0 mPa·s or more, image density is high and good. The reason is thought that copolymer of the present invention is bound to a polyvalent metal ion eluted from a recording medium to thereby improve agglutination of the pigment. Meanwhile, when the viscosity is 30.0 mPa·s or less, storage stability of the pigment is good because viscosities of the pigment dispersion and the ink do not increase.

In cases where the copolymer of the present invention is used as a dispersing agent, the amount of the copolymer may be selected appropriately depending on the kind of pigment. The amount thereof is 0.005 parts by mass to 5 parts by mass relative to 1 part by mass of the pigment. More preferable is 0.01 parts by mass to 2 parts by mass relative to 1 part by mass of the pigment, and further more preferable is 0.02 parts by mass to 0.5 parts by mass relative to 1 part by mass of the pigment. When the amount thereof is 0.005 parts by mass to 5 parts by mass, both of dispersibility of the pigment and stability over time of the ink are improved. When the amount thereof is 0.01 parts by mass to 2 parts by mass, these effects are further improved. In particular, the amount thereof is 0.02 parts by mass to 0.5 parts by mass, stability over time of the ink is further improved.

Accordingly, a dispersing agent described hereinafter and the copolymer may be used in combination as long as the above effect is not impaired.

### (Water)

Water used in the present invention can be used pure water such as ion-exchanged water, ultrafiltrated water, MilII-Q water, and distilled water; or ultrapure water.

The amount of water is preferably 20% by mass to 60% by mass relative to a total amount of the ink.

### (Water-Soluble Solvent)

A water-soluble solvent used in the present invention is required to improve ejection stability of the ink because it gives moisturizing effect to the ink composition. The amount of the solvent is preferably 10% by mass to 50% by mass relative to a total amount of the ink. When the amount thereof is less than 10% by mass, the ink is likely to evaporate moisture. Then, moisture evaporation causes a viscous ink to clog in an ink supply system of the inkjet recording device. When the amount thereof is more than 50% by mass, clogging of the viscous ink is difficult to cause in the inkjet recording device. However, image density of the recorded matter may be declined because reduction of the pigment and the resin on a solid basis is required in order to obtain a desirable viscosity of the ink.

The water-soluble solvents used in the present invention are shown as follows but are not particularly limited. Examples thereof include polyhydric alcohols such as ethylene glycol, diethylene glycol, 1,3-butanediol, 3-methyl-1,3-butylglycol, triethylene glycol, polyethylene glycol, polypropylene glycol, 1,5-pentanediol, 1,6-hexanediol, glycerin, 1,2,6-hexanetriol, 2-ethyl-1,3-hexanediol, 2,2,4-trimethyl-1,3-pentanediol, 1,2,4-butanetriol, 1,2,3-butanetriol, and petriol; polyhydric alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylen glycol monoethyl ether; polyhydric alcohol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethylimidazolidinone, ε-caprolactam, γ-butyrolactone; amides such as formamide, N-methylformamide, N,N-dimethylformamide; amines such as monoethanolamine, diethanolamine, triethylamine; sulfur-containing compounds such as dimethyl sulfoxide, sulfolane, thiodiethanol; and propylene carbonate, and ethylene carbonate.

These may be used alone or in combination. Among them, incorporation of 1,3-butanediol, diethyleneglycol, 2,2,4-trimethyl-1,3-pentanediol, triethylene glycol, and/or glycerin can provide an excellent effect in preventing ejection failure due to moisture evaporation. Incorporation of glycerin is particularly preferable.

### (Pigment)

An amount of a pigment to be used in the present invention contained in an ink is preferably 0.1% by mass to 20.0% by mass. A volume average particle diameter (D50) of the pigment is preferably 150 nm or less.

Here, the volume average particle diameter (D50) of the pigment is a value measured by means of MICROTRAC UPA (product of Nikkiso Co., Ltd.) through a dynamic light scattering method in an environment of 23° C. and 55% RH.

A type of the pigment is not particularly limited and may be appropriately selected depending on the intended purpose. For example, the pigment may be an inorganic pigment or an organic pigment. These may be used alone or in combination.

Examples of the inorganic pigment include titanium oxide, iron oxide, calcium carbonate, barium sulfate, aluminum hydroxide, barium yellow, navy blue, cadmium red, chrome yellow, metal powder, and carbon black. Among them, carbon black is preferable. Examples of the carbon black include product matters which are produced by a contact method, a furnace method, and a thermal method, which are known.

Examples of the organic pigment include an azo pigment, an azomethine pigment, a polycyclic pigment, a dye chelate, a nitro pigment, a nitroso pigment, and aniline black. Among them, the azo pigment and the polycyclic pigment are preferable.

Examples of the azo pigment include azo lake, an insoluble azo pigment, a condensed azo pigment, and a chelate azo pigment. Examples of the polycyclic pigment include a phthalocyanine pigment, a perylene pigment, a perinone pigment, an anthraquinone pigment, a quinacridone pigment, a dioxazine pigment, an indigo pigment, a thioindigo pigment, an isoindolinone pigment, a quinophthalone pigment, and a rhodamine B lake pigment. Examples of the dye chelate include a basic dye-type chelate and an acidic dye-type chelate.

Examples of a pigment for a black ink include carbon blacks (C.I. Pigment Black 7) such as furnace black, lampblack, acetylene black, and channel black; metals such as copper, iron (C.I. Pigment Black 11), and titanium oxide; and organic pigments such as aniline black (C.I. Pigment Black 1).

Preferable examples of the carbon black include carbon blacks produced by a furnace method or a channel method, with a primary particle diameter of 15 nm to 40 nm, a specific surface area as measured by a BET method of 50 m²/g to 300 m²/g, a DBP oil absorption amount of 40 mL/100 g to 150 mL/100 g, a volatile matter content of 0.5% to 10%, and a pH of 2 to 9.

Commercially available products can be used for the carbon black. Example thereof include No. 2300, No. 900, MCF-88, No. 33, No. 40, No. 45, No. 52, MA7, MA8, MA100, and No. 2200B (all products of Mitsubishi Chemical Corporation); RAVEN 700, RAVEN 5750, RAVEN 5250, RAVEN 5000, RAVEN 3500, and RAVEN 1255 (all products of Columbia Corp); REGAL 400R, REGAL 330R, REGAL 660R, MOGUL L, MONARCH 700, MONARCH 800, MONARCH 880, MONARCH 900, MONARCH 1000, MONARCH 1100, MONARCH 1300, and MONARCH 1400 (all products of Cabot Corporation); and COLOR BLACK FW1, COLOR BLACK FW2, COLOR BLACK FW2V, COLOR BLACK FW18, COLOR BLACK FW200, COLOR BLACK S150, COLOR BLACK S160, COLOR BLACK S170, PRINTEX 35, PRINTEX U, PRINTEX V, PRINTEX 140U, PRINTEX 140V, SPECIAL BLACK 6, SPECIAL BLACK 5, SPECIAL BLACK 4A, and SPECIAL BLACK 4 (all products of Degussa AG).

A pigment for a yellow ink is not particularly limited and may be appropriately selected depending on the intended purpose. Examples thereof include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 114, C.I. Pigment Yellow 120, C.I. Pigment Yellow 128, C.I. Pigment Yellow 129, C.I. Pigment Yellow 138, C.I. Pigment Yellow 150, C.I. Pigment Yellow 151, C.I. Pigment Yellow 154, C.I. Pigment Yellow 155, C.I. Pigment Yellow 174, and C.I. Pigment Yellow 180.

A pigment for a magenta ink is not particularly limited and may be appropriately selected depending on the intended purpose. Examples thereof include C.I. Pigment Red 5, C.I. Pigment Red 7, C.I. Pigment Red 12, C.I. Pigment Red 48 (Ca), C.I. Pigment Red 48 (Mn), C.I. Pigment Red 57 (Ca), C.I. Pigment Red 57:1, C.I. Pigment Red 112, C.I. Pigment Red 122, C.I. Pigment Red 123, C.I. Pigment Red 146, C.I. Pigment Red 168, C.I. Pigment Red 176, C.I. Pigment Red 184, C.I. Pigment Red 185, C.I. Pigment Red 202, and Pigment Violet 19.

A pigment for a cyan ink is not particularly limited and may be appropriately selected depending on the intended purpose. Examples thereof include C.I. Pigment Blue 1, C.I. Pigment Blue 2, C.I. Pigment Blue 3, C.I. Pigment Blue 15, C.I. Pigment Blue 15:3, C.I. Pigment Blue 15:4, C.I. Pigment Blue 15:34, C.I. Pigment Blue 16, C.I. Pigment Blue 22, C.I. Pigment Blue 60, C.I. Pigment Blue 63, C.I. Pigment Blue 66; and C.I. Bat Blue 4, and C.I. Bat Blue 60.

Pigments that are newly produced for the present invention may also be used in each of the inks of the present invention.

Note that, use of Pigment Yellow 74 as a yellow pigment, Pigment Red 122 and Pigment Violet 19 as a magenta pigment, and Pigment Blue 15:3 as a cyan pigment makes it possible to obtain a balanced ink which is excellent in color tone and light resistance.

In addition, grafted or capsulated pigments which are covered with surfactants such as a dispersing agent or resins may be used for the pigment of the present invention. However, use of the compound of the present invention as the dispersing agent is more preferable.

The pigments described above may be used in combination as long as the effect is not impaired.

### (Other Ingredients)

The other ingredients, which are used in formulation of the inkjet recording ink of the present invention, are not particularly limited and may be appropriately selected depending on the intended purpose. Examples thereof include a dispersing agent, a pH adjuster, a water-dispersible resin, a antiseptic and antifungal agent, a chelating reagent, a rust preventive agent, an antioxidant, a ultraviolet absorber, an oxygen absorber, and a light stabilizer.

### (Dispersing Agent)

The dispersing agent is preferably a phosphoric acid group-containing copolymer of the present invention. Examples of the dispersing agent include various surfactants such as an anionic surfactant, a cationic surfactant, an amphoteric surfactant, and a nonionic surfactant; and polymer dispersing agents. These may be used alone or in combination.

Examples of the anionic surfactant include alkyl sulfocarboxylate, α-olefin sulfonate, polyoxyethylene alkyl ether acetate, N-acylamino acid and salts thereof, N-acyl methyl taurine salt, polyoxyalkyl ether sulfate, polyoxyethylene alkyl ether phosphate, rosin acid soap, castor-oil sulfate ester salt, lauryl alcohol sulfate ester salt, alkylphenol type phosphate ester, naphthalenesulfonate formalin condensate, alkyl-type phosphate ester, alkyl aryl sulfonate, diethyl sulfosuccinate, diethyl hexyl sulfosuccinate, and dioctyl sulfosuccinate.

Examples of the cationic surfactant include 2-vinylpyridine derivatives and poly-4-vinylpyridine derivatives.

Examples of the amphoteric surfactant include lauryl dimethylamino acetic acid betaine, 2-alkyl-N-carboxymethyl-N-hydroxyethylimidazolinium betaine, coconut oil fatty acid amide propyl dimethylamino acetic acid betaine, polyoctyl polyaminoethyl glycine, and imidazoline derivatives.

Examples of the nonionic surfactant include:

ether-based surfactants, such as polyoxyethylene nonylphenyl ether, polyoxyethylene octylphenyl ether, polyoxyethylene dodecyl phenyl ether, polyoxyethylene lauryl ether, polyoxyethylene oleyl ether, polyoxyethylene alkyl ether, and polyoxyaralkyl alkyl ether;

ester-based surfactants, such as polyoxyethylene oleate, polyoxyethylene oleate ester, polyoxyethylene distearate ester, sorbitan laurate, sorbitan monostearate, sorbitan monooleate, sorbitan sesquioleate, polyoxyethylene monooleate, and polyoxyethylene stearate; and

acetylene glycol-based surfactants, such as 2,4,7,9-tetramethyl-5-decyne-4,7-diol, 3,6-dimethyl-4-octyne-3,6-diol, and 3,5-dimethyl-1-hexyne-3-ol.

### (pH Adjuster)

The pH adjuster is not particularly limited and may be appropriately selected depending on the intended purpose, so long as it can adjust the pH to 8.5 to 11, preferably 9 to 11, without adversely affecting the inkjet ink that will be prepared. Examples thereof include alcohol amines, hydroxides of alkali metal elements, hydroxides of ammonium, hydroxides of phosphonium and carbonates of alkali metals. When the pH is less than 8.5 or greater than 11, a large amount of an inkjet head or an ink supply unit is dissolved out, potentially leading to a defect such as deterioration, leakage, or ejection failure of the resultant ink. When the pH is less than 8.5, the resultant ink is decreased in the pH during storage, so that polymer particles may be increased in particle diameter to aggregate together.

For example, the pH can be measured by a pH meter HM-30R (manufactured by DKK-TOA Corporation).

Examples of the alcohol amines include diethanolamine, triethanolamine, and 2-amino-2-ethyl-1,3 propanediol. Examples of the hydroxides of alkali metal elements include lithium hydroxide, sodium hydroxide, and potassium hydroxide. Examples of the hydroxides of ammonium include ammonium hydroxide, quaternary ammonium hydroxide, and quaternary phosphonium hydroxide. Examples of the carbonates of alkali metals include lithium carbonate, sodium carbonate, and potassium carbonate.

### (Water-Dispersible Resin)

The water-dispersible resin is excellent in film formability performance (image formability performance), and has high water repellency, water resistance, and weather resistance. Accordingly, it is useful for recording an image which is water resistant and has high image density (high color-developability).

Examples thereof include condensation-type synthetic resins, addition-type synthetic resins, and natural polymer compounds.

Examples of the condensation-type synthetic resin include a polyester resin, a polyurethane resin, a polyepoxy resin, a polyamide resin, a polyether resin, a poly(meth)acrylic resin, an acryl-silicone resin, and a fluorine-based resin. Examples of the addition-type synthetic resin include a polyolefin resin, a polystyrene-based resin, a polyvinyl alcohol-based resin, a polyvinyl ester-based resin, a polyacrylic acid-based resin, and an unsaturated carboxylic acid-based resin. Examples of the natural polymer compounds include celluloses, rosins, and natural rubber.

Among them, preferable are polyurethane resin particles, acryl-silicone resin particles, and fluorine-based resin particles.

A volume average particle diameter (D50) of the water-dispersible resin correlates with the viscosity of a dispersion. In the case of water-dispersible resins which are the same in composition as each other, but different in the volume average particle diameter (D50) from each other, as the particle diameter becomes smaller, the viscosity increases with the same solid contents. In order to prevent the ink from having excessively high viscosity, the water-dispersible resin preferably has the volume average particle diameter of 50 nm or more. When the volume average particle diameter is several ten micrometers, the resultant ink cannot be used because the particle diameter is larger than a nozzle opening of an inkjet head. When the particle diameter is smaller than the nozzle opening, the presence of large particles in the ink deteriorates ejection stability. In order to prevent the ejection stability from being impaired, the volume average particle diameter (D50) is preferably 200 nm or less.

Here, the volume average particle diameter (D50) thereof was measured by means of MICROTRAC UPA (product of Nikkiso Co., Ltd.) through a dynamic light scattering method in an environment of 23° C. and 55% RH.

The water-dispersible resin preferably has a function to fix a water-dispersible pigment onto a paper surface, and forms a film at a normal temperature to improve fixability of coloring matters. Therefore, the minimum film forming temperature (MFT) of the water-dispersible resin is preferably 30° C. or less.

When the glass transition temperature of the water-dispersible resin is −40° C. or lower, a resin coating is increased in consistency, leading to tack in printed matter. Therefore, the glass transition temperature of the water-dispersible resin is preferably −30° C. or higher. The amount of the water-dispersible resin contained in the ink is preferably 1% by mass to 15% by mass, more preferably 2% by mass to 7% by mass on a solid basis.

### (Antiseptic and Antifungal Agent)

Examples of the antiseptic and antifungal agent include sodium dehydroacetate, sodium sorbate, 2-pyridinethiol-1-oxide sodium, sodium benzoate, and pentachlorophenol sodium.

### (Chelating Reagent)

Examples of the chelating reagent include sodium ethylenediamine tetraacetate, sodium nitrilotriacetate, sodium hydroxyethyl ethylenediamine triacetate, sodium diethylenetriamine pentaacetate, and sodium uramil diacetate.

### (Rust Preventive Agent)

Examples of the rust preventive agent include acidic sulfite, sodium thiosulfate, ammonium thiodiglycolate, diisopropyl ammonium nitrite, pentaerythritol tetranitrate, and dicyclohexyl ammonium nitrite.

### (Antioxidant)

Examples of the antioxidant include phenolic antioxidants (including hindered phenolic antioxidants), amine-based antioxidants, sulfur-based antioxidants, and phosphorus-based antioxidants.

### (Ultraviolet Absorber)

Examples of the ultraviolet absorber include benzophenone-based ultraviolet absorbers, benzotriazole-based ultraviolet absorbers, salicylate-based ultraviolet absorbers, cyanoacrylate-based ultraviolet absorber, and nickel complex salt-based ultraviolet absorbers.

### (Production Method of Inkjet Recording Ink)

An inkjet recording ink of the present invention is produced by dispersing or dissolving water, a water-soluble organic solvent, a pigment, a phosphate group-containing copolymer, and, if necessary, other ingredients into an aqueous medium, followed by appropriately stirring and mixing.

For example, the dispersing can be performed with a sand mill, a homogenizer, a ball mill, a paint shaker, or an ultrasonic disperser. The stirring and mixing can be performed with a stirrer with a typical stirring blade, a magnetic stirrer, or a high speed disperser.

Physical properties of an inkjet ink of the present invention are not particularly limited and may be appropriately selected depending on the intended purpose. For example, a viscosity and a surface tension are preferable within the following range.

For example, the viscosity of the inkjet ink is preferably 3 mPa·s to 20 mPa·s at 25° C. When the viscosity is 3 mPa·s or more, an effect of improving printing density and character quality can be attained. When the viscosity is 20 mPa·s or less, ejection property can be ensured.

For example, the viscosity can be measured at 25° C. by means of a viscometer (RE500L, product of Toki Sangyo Co., Ltd.).

A surface tension of the inkjet ink is preferably 40 mN/m or less at 25° C. When the surface tension is more than 40 mN/m, leveling of the ink is not likely to generate on a recording medium, and the ink take a long time to be dried.

### <Ink Cartridge>

An ink cartridge of the present invention includes a container and an ink of the present invention housed in the container. The ink cartridge may further include other members, which are appropriately selected as needed. The shape, structure, size, and material of the container are not particularly limited and may be appropriately selected depending on the intended purpose. For example, the container having an ink bag made of aluminum laminated film or resin film may be used preferably.

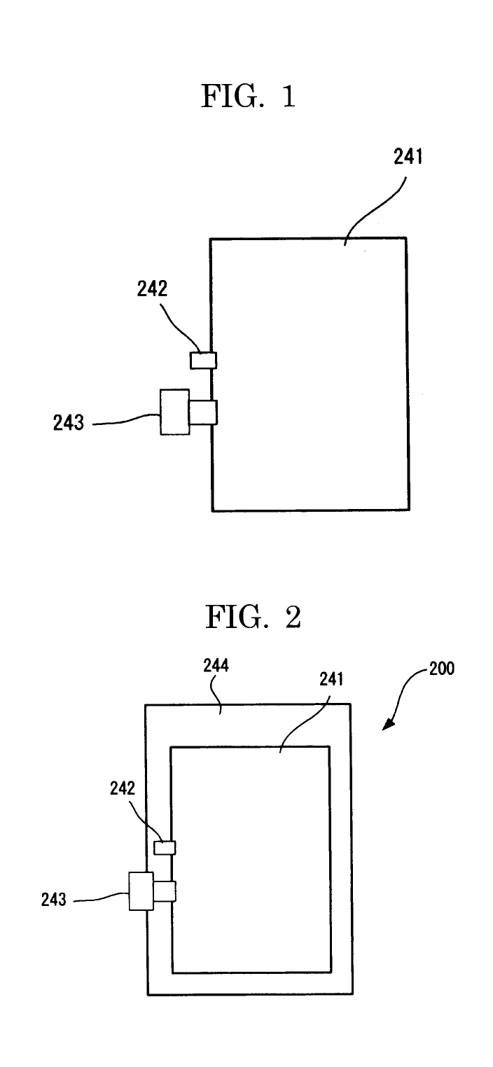

One aspect of the ink cartridge of the present invention will be described with reference to FIGS. 1 and 2. FIG. 1 is a schematic plan diagram illustrating one example of the ink cartridge of the present invention. FIG. 2 is a schematic plan diagram illustrating the ink cartridge of the present invention illustrated in FIG. 1 and a case (exterior) thereof.

As shown in FIG. 1, in an ink cartridge 200, an ink bag 241 is filled with ink via an ink inlet 242. After the air is discharged therefrom, the ink inlet 242 is sealed by welding. When using, a needle provided in a device body is stuck into an ink outlet 243, which is made of a rubber member, to thereby supply the ink to the device. The ink bag 241 is made from a packaging material such as an aluminum laminated film with no air permeability. As shown in FIG. 2, the ink bag 241 is usually housed in a cartridge case 244 which is made of plastics, and is configured to be detachably mounted on various inkjet recording devices.

### <Inkjet Recording Device and Inkjet Recording Method>

An inkjet recording device of the present invention includes an ink jetting unit configured to allow the inkjet recording ink of the present invention to jet from a recording head, to thereby record an image on the recording medium; and, if necessary, further includes appropriately selected other units such as a stimulus generating unit and a controlling unit.

An inkjet recording method using the ink of the present invention includes an ink jetting step, and if necessary, includes selected appropriately other steps such as a stimulus generating step, a controlling step.

The inkjet recording method using the ink of the present invention can be suitably performed by means of the inkjet recording device of the present invention, and the ink jetting step can be suitably performed by means of the ink jet recording device, and the ink jetting step can be suitably performed by means of the ink jetting unit. Moreover, the aforementioned other steps can be suitably performed by means of the aforementioned other units.

A method for producing an inkjet recorded matter of the present invention includes an ink jetting step configured to apply a stimulus to the inkjet recording ink of the present invention by means of the ink jetting unit and to allow the ink jet from a recording head to record an image on the recording medium.

The ink jetting step is a step of applying a stimulus to the inkjet ink of the present invention to allow the inkjet ink to jet, to thereby form an image.

The ink jetting unit is a unit configured to apply a stimulus to the inkjet ink of the present invention to allow the inkjet ink to jet, to thereby form an image on a recording medium. The ink jetting unit is not particularly limited. Examples thereof include various nozzles used for ejecting inks.

The stimulus can be generated, for example, by a stimulus generating unit. The stimulus is not particularly limited and may be appropriately selected depending on the intended purpose. Examples thereof include heat (temperature), pressure, vibration, and light. These may be used alone or in combination. Among them, heat and pressure are suitable. The stimulus generating unit may be a heating device, a pressurizing device, a piezoelectric element, a vibration generator, an ultrasonic wave oscillator, and a light. Specific examples of the stimulus generating unit include a piezoelectric actuator such as a piezoelectric element; a thermal actuator utilizing a phase change due to film boiling of liquid caused by using an electric-heat transducer such as a heat element; a shape memory alloy actuator utilizing a metal phase change due to a temperature change; and an electrostatic actuator utilizing electrostatic force.

An embodiment of the jetting of the ink is not particularly limited, and varies depending on the stimulus. In the case where the stimulus is “heat”, for example, there is a method in which a thermal energy corresponding to a recording signal is applied to the ink in a recording head, for example, by a thermal head, to thereby generate bubbles in the ink by the action of the thermal energy, and then, by the action of pressure of the bubbles, droplets of the ink are allowed to be ejected from a nozzle hole of the recording head. Meanwhile, in the case where the stimulus is “pressure”, there is a method in which voltage is applied to a piezoelectric element adhered to a pressure chamber in an ink flow channel within a recording head, to thereby bend the piezoelectric element, and reduce a volume of the pressure chamber, so that droplets of the ink are allowed to be ejected from a nozzle hole of the recording head.

The controlling unit is not particularly limited and may be appropriately selected depending on the intended purpose, as long as it can control operation of each of the units. Examples thereof include a device such as a sequencer and a computer.

One embodiment for performing an inkjet recording method of the present invention by an inkjet recording device of the present invention will be described hereinafter with reference to figures.

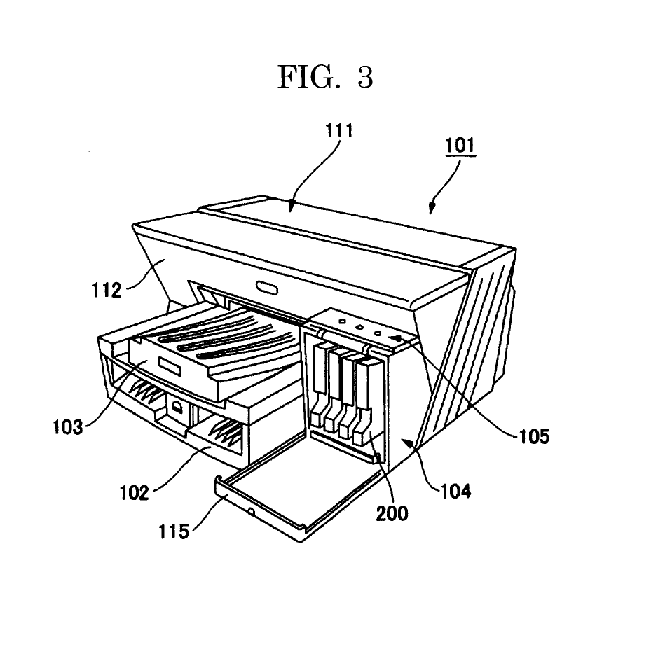

FIG. 3 is a perspective view illustrating one example of an inkjet recording method of the present invention.

The inkjet recording device illustrated in FIG. 3 contains a device main body 101, a paper feeding tray 102 provided in the device main body 101 and configured to feed a sheet of paper, a paper discharging tray 103 provided in the device main body 101 and configured to store a sheet of paper on which an image has been recorded (formed), and an ink cartridge loading section 104, which is placed in the front end side of the surface 112 of the device main body 101, stuck out forward from the front surface 112, and placed at a lower position than a head cover 111. On an upper surface of the ink cartridge loading section 104, a control section 105 such as operation keys and a display is provided. The ink cartridge loading section 104 has a front cover 115 that can be opened and closed for attaching or detaching the ink cartridge 200.

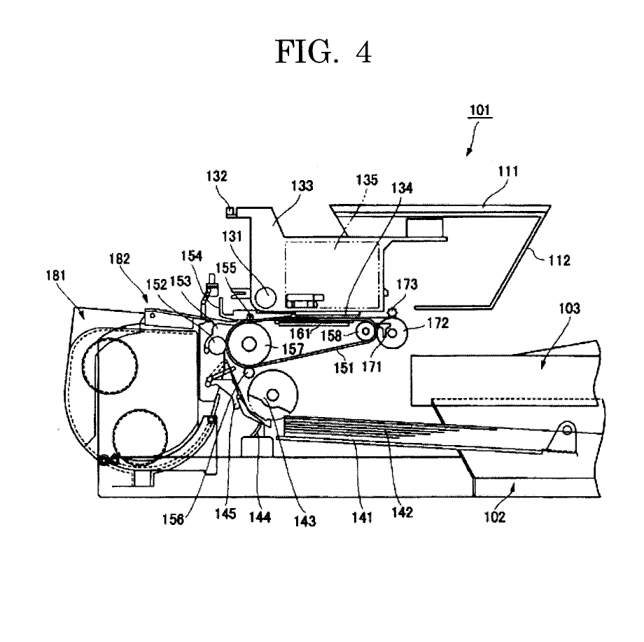

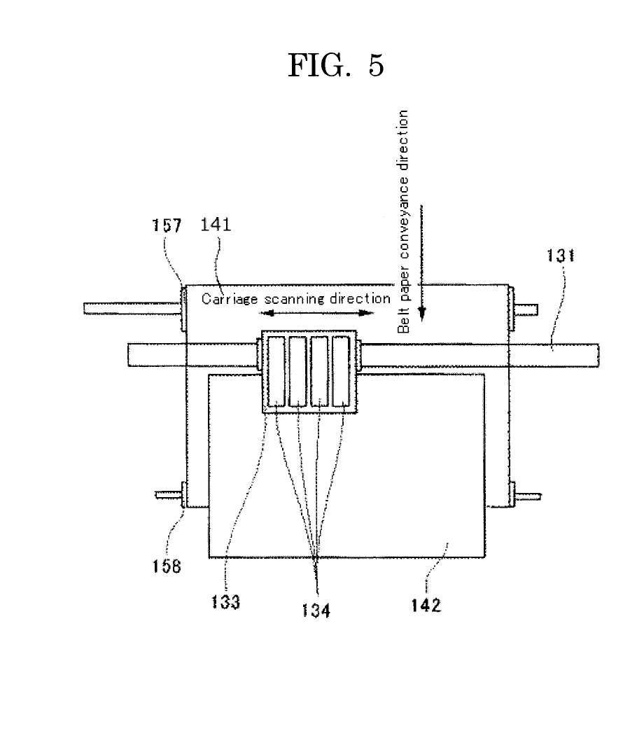

In the device main body 101, as illustrated in FIGS. 4 and 5 (partially enlarged cross-sectional view of the inkjet recording device illustrated in FIG. 3), a carriage 133 is slidably held in a main-scanning direction by a guide rod 131, which is a guide member horizontally bridged between left and right side plates, and a stay 132; and is moved for scanning in an arrow direction illustrated in FIG. 5 by a main scanning motor.

A recording head 134 composed of four inkjet recording heads configured to eject ink droplets of yellow (Y), cyan (C), magenta (M) and black (Bk) is installed in the carriage 133 such that a plurality of ink ejection outlets are aligned in the direction intersecting the main-scanning direction and that the ink droplet ejection direction faces downward.

For each of the inkjet recording heads constituting the recording head 134, it is possible to use, for example, a head provided with any of the following energy-generating units for ejecting ink: a piezoelectric actuator such as a piezoelectric element; a thermal actuator utilizing a phase change due to film boiling of liquid caused by using an electric-heat transducer such as a heat element; a shape memory alloy actuator utilizing a metal phase change due to a temperature change; and an electrostatic actuator utilizing electrostatic force. Also, the carriage 133 is provided with sub-tanks 135 for each color configured to supply each color ink to the recording head 134. Each sub-tank 135 is supplied and replenished with the ink from the ink cartridge 200 loaded into the ink cartridge loading section 104, via an ink supply tube which is not illustrated.

Meanwhile, as a paper feeding section configured to feed sheets of paper 142 loaded on a paper loading section (pressurizing plate) 141 of the paper feed tray 102, there are provided a half-moon roller (paper feeding roller 143) which feeds sheets of paper 142 one by one from the paper loading section 141, and a separation pad 144 which faces the paper feeding roller 143 and is formed of a material with a large friction coefficient. This separation pad 144 is biased toward the paper feeding roller 143 side.

As a conveyance section configured to convey the sheet of paper 142, which has been fed from this paper feeding section, underneath the recording head 134, there are provided a conveyance belt 151 configured to convey the sheet of paper 142 by means of electrostatic adsorption; a counter roller 152 configured to convey the sheet of paper 142, which is fed from the paper feeding section via a guide 145, while the sheet of paper is sandwiched between the counter roller and the conveyance belt 151; a conveyance guide 153 configured to make the sheet of paper 142, which is fed upward in the substantially vertical direction, change its direction by approximately 90° and thusly run along the conveyance belt 151; and an end pressurizing roller 155 biased toward the conveyance belt 151 side by a pressing member 154.

Also, there is provided a charging roller 156 as a charging unit configured to charge a surface of the conveyance belt 151. The conveyance belt 151 is an endless belt; and is capable of rotating around in a belt conveyance direction by stretching between a conveyance roller 157 and a tension roller 158. The conveyance belt 151 includes, for example, a surface layer serving as a paper adsorbing surface, which is formed of a resinous material such as an ethylene-tetrafluoroethylene copolymer (ETFE) having a thickness of approximately 40 μm for which resistance control has not been conducted; and a back layer (intermediate resistance layer, ground layer) which is formed of the same material as the surface layer, and for which resistance control has been conducted using carbon. On the back of the conveyance belt 151, a guide member 161 is placed correspondingly to a region where printing is carried out by the recording head 134.

Additionally, as a paper discharge section configured to discharge the sheet of paper 142 on which an image has been recorded by the recording head 134, there are provided a separation claw 171 configured to separate the sheet of paper 142 from the conveyance belt 151, a paper discharge roller 172, and a paper discharge roller 173, with the paper discharge tray 103 being placed below the paper discharge roller 172.

A double-sided paper feeding unit 181 is detachably mounted on a rear surface portion of the device main body 101. The double-sided paper feeding unit 181 takes in the sheet of paper 142 returned by rotation of the conveyance belt 151 in the opposite direction and reverses it, then refeeds it between the counter roller 152 and the conveyance belt 151. Additionally, a manual paper feeding section 182 is provided on an upper surface of the double-sided paper feeding unit 181.

In the inkjet recording device, the sheets of paper 142 are fed one by one from the paper feeding section, and the sheets of paper 142 fed upward in the substantially vertical direction is guided by the guide 145 and conveyed with being sandwiched between the conveyance belt 151 and the counter roller 152. Further, an end of the sheet of paper is guided by the conveyance guide 153 and pressed onto the conveyance belt 151 by the end pressurizing roller 155, so that the conveyance direction of the sheet of paper is changed by approximately 90°. On this occasion, the conveyance belt 151 is charged by the charging roller 156, and the sheet of paper 142 is electrostatically adsorbed onto the conveyance belt 151 and thusly conveyed. Here, by driving the recording head 134 according to an image signal while moving the carriage 133, ink droplets are ejected onto the sheet of paper 142 having stopped so as to perform recording for one line. Thereafter, the sheet of paper 142 is conveyed by a predetermined distance, and then recording for the next line is carried out.

On receipt of a recording completion signal or a signal indicating that a rear end of the sheet of paper 142 has reached a recording region, recording operation is finished, and the sheet of paper 142 is discharged onto the paper discharge tray 103. Once an amount of the ink remaining in the sub-tanks 135 has been detected as too small, a required amount of the ink is supplied from the ink cartridge 200 into the sub-tanks 135.

As for the inkjet recording device, when the ink in the ink cartridge 200 of the present invention has been used up, it is possible to replace only the ink bag inside the ink cartridge by dismantling a housing of the ink cartridge 200. Also, even when the ink cartridge 200 is vertically mounted and employs a front-loading configuration, the ink can be supplied stably. Therefore, even when the device main body 101 is installed with little space over it, for example when it is stored in a rack or when an object is placed over the device main body 101, the ink cartridge 200 can be easily replaced.

Note that, a serial (shuttle) type inkjet recording device in which the carriage is used for scanning and to which the present invention is applied is described above, but the present invention can be also applied to a line type inkjet recording device equipped with a line-type head.

The inkjet recording device of the present invention can be applied in various recording by the inkjet recording system, and can be particularly suitably applied to an inkjet recording printer, a facsimile, a photocopier, and a multifunction printer (printer-fax-copier).

### (Ink Recorded Matter)

An ink recorded matter recorded by means of an inkjet recording method of the present invention is an ink recorded matter of the present invention. That is, the ink recorded matter of the present invention includes an image recorded by means of the inkjet recording ink of the present invention on a recording medium (recording media). The storage medium is not particularly limited and may be appropriately selected depending on the intended purpose. Examples of the recording media include plain paper, coated paper for printing, glossy paper, special paper, cloth, film, and OHP sheet. These may be used alone or in combination. Among them, at least one of the plain paper and the coated paper for printing are preferable. The plain paper is advantageous from the view point of cheapness. Additionally, the coated paper for printing is preferable because it is relatively cheaper than the glossy paper and supplies smooth and gloss images. However, drying property thereof was wrong. The drying property of the ink of the present invention is improved and is usable for the ink recorded matter.

The ink recorded matter of the present invention has high image quality, has no bleeding, is excellent in stability over time, and can be suitably used in various applications, for example, as material on which characters or images are recorded.

### EXAMPLES

The present invention will be described hereinafter in more detail with reference to Examples and Comparative Examples, but the present invention is not limited to Examples.

Note that, numerical values described in Tables denote % by mass.

Also, the following abbreviations represent the following compounds.

| | | |
|---|---|---|
| PA; | Acid phosphoxy ethyl acrylate; | Formula 3-1 |
| | (LIGHT ACRYLATE P-1A: product of Kyoeisha Chemical Co., Ltd) | |
| PMA; | Acid phosphoxy ethyl methaxrylate; | Formula 3-2 |
| | (PHOSMER M; product of Uni-Chemical Co., Ltd.) | |
| PPEGMA; | Acid phosphoxy polyoxyethylene glycol monomethacrylate; | Formula 3-3 |
| | (PHOSMER PE; product of Uni-Chemical Co., Ltd.) | |
| PPPGMA; | Acid phosphoxy polyoxy propylene glycol monomethacrylate; | Formula 3-4 |
| | (PHOSMER PP; product of Uni-Chemical Co., Ltd.) | |
| MPEGA; | Methoxy polyethylene glycol acrylate; | Formula 4-1 |
| | (BLEMMER AME-400: product of NOF CORPORATION) | |
| MPEGMA9; | Methoxy polyethylene glycol methacrylate; | Formula 4-2 |
| | (BLEMMER PME-400: product of NOF CORPORATION) | |
| EDEGA; | Ethoxy diethylene glycol acrylate; | Formula 4-3 |
| | (LIGHT ACRYLATE EC-A: product of Kyoeisha Chemical Co., Ltd) | |
| BDEGMA; | Butoxy diethylene glycol methacrylate; | Formula 4-4 |
| | (LIGHT ACRYLATE BC: product of Kyoeisha Chemical Co., Ltd) | |
| MTEGA; | Methoxy triethylene glycol acrylate; | Formula 4-5 |
| | (LIGHT ACRYLATE MTG-A: product of Kyoeisha Chemical Co., Ltd) | |
| MPEGMA30; | Methoxy polyethylene glycol methacrylate; | Formula 4-6 |
| | (LIGHT ESTER 041MA: product of Kyoeisha Chemical Co., Ltd) | |
| | MDPGMA; Methoxy dipropylene glycol acrylate; | Formula 4-7 |
| | (LIGHT ACRYLATE DPM-A: product of Kyoeisha Chemical Co., Ltd) | |
| AIBN; | Azobisisobutyronitrile | |

### (Measurement of Viscosity of Copolymers)

Synthesized copolymers were measured by means of a rotational viscometer (RE500L-type viscometer-cone plate type, product of Told Sangyo Co., Ltd). Specific operations are shown as follows. At 25° C., 1.1 mL of an aqueous solution of copolymer having a solid content of 10% by mass was sampled and charged into a sample cup of the viscometer. The sample cup was installed in a body of the viscometer and the body was left to stand for one minute. Then, a rotation speed was adjusted in accordance with each of the samples and a rotor of the viscometer was rotated. A value of the viscometer was read after one minute.

### Synthesis Examples of Copolymers

### Preparation of Copolymer 1

PMA (9.0 g), MPEGMA9 (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 1. The obtained aqueous solution of the Copolymer 1 was found to have a viscosity of 13.9 mPa·s.

### Preparation of Copolymer 2

PMA (9.0 g), MPEGMA9 (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide so that a neutralization rate was 50% and then purified through a dialysis membrane for 3 days. After purification, the concentration was accurately adjusted to 10% by mass to thereby obtain an aqueous solution of Copolymer 2. The obtained aqueous solution of the Copolymer 2 was found to have a viscosity of 8.3 mPa·s.

### Preparation of Copolymer 3

PMA (9.0 g), MPEGA (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 3. The obtained aqueous solution of the Copolymer 3 was found to have a viscosity of 14.5 mPa·s.

### Preparation of Copolymer 4

PMA (9.0 g), EDEGA (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 4. The obtained aqueous solution of the Copolymer 4 was found to have a viscosity of 14.8 mPa·s.

### Preparation of Copolymer 5

PMA (9.0 g), BDEGMA (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 5. The obtained aqueous solution of the Copolymer 5 was found to have a viscosity of 14.9 mPa·s.

### Preparation of Copolymer 6

PMA (9.0 g), MTEGA (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 6. The obtained aqueous solution of the Copolymer 6 was found to have a viscosity of 12.9 mPa·s.

### Preparation of Copolymer 7

PMA (9.0 g), MPEGMA30 (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 7. The obtained aqueous solution of the Copolymer 7 was found to have a viscosity of 16.1 mPa·s.

### Preparation of Copolymer 8

PMA (9.0 g), MDPGMA (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 8. The obtained aqueous solution of the Copolymer 8 was found to have a viscosity of 13.8 mPa·s.

### Preparation of Copolymer 9

PMA (9.0 g), MPEGMA9 (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with potassium hydroxide and then purified through a dialysis membrane for 3 days. After purification, the concentration was accurately adjusted to 10% by mass to thereby obtain an aqueous solution of Copolymer 9. The obtained aqueous solution of the Copolymer 9 was found to have a viscosity of 14.0 mPa·s.

### Preparation of Copolymer 10

PMA (9.0 g), MPEGMA9 (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with lithium hydroxide and then purified through a dialysis membrane for 3 days. After purification, the concentration was accurately adjusted to 10% by mass to thereby obtain an aqueous solution of Copolymer 10. The obtained aqueous solution of the Copolymer 10 was found to have a viscosity of 14.1 mPa·s.

### Preparation of Copolymer 11

PMA (9.0 g), MPEGMA9 (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with monoethanolamine (EA) and then purified through a dialysis membrane for 3 days. After purification, the concentration was accurately adjusted to 10% by mass to thereby obtain an aqueous solution of Copolymer 11. The obtained aqueous solution of the Copolymer 11 was found to have a viscosity of 13.5 mPa·s.

### Preparation of Copolymer 12

PMA (9.0 g), MPEGMA9 (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with dimethylethanolamine (DMEA) and then purified through a dialysis membrane for 3 days. After purification, the concentration was accurately adjusted to 10% by mass to thereby obtain an aqueous solution of Copolymer 12. The obtained aqueous solution of the Copolymer 12 was found to have a viscosity of 13.8 mPa·s.

### Preparation of Copolymer 13

PA (9.0 g), MPEGMA9 (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 13. The obtained aqueous solution of the Copolymer 13 was found to have a viscosity of 12.8 mPa·s.

### Preparation of Copolymer 14

PPEGMA (9.0 g), MPEGMA9 (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 14. The obtained aqueous solution of the Copolymer 14 was found to have a viscosity of 13.0 mPa·s.

### Preparation of Copolymer 15

PPPGMA (9.0 g), MPEGMA9 (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 15. The obtained aqueous solution of the Copolymer 15 was found to have a viscosity of 13.1 mPa·s.

### Preparation of Copolymer 16

PMA (4.0 g), MPEGMA9 (16.0 g), and ethanol (380.0 g) were charged into a 4-neck flask and stirred to thereby obtain a homogeneous solution. After nitrogen had been injected to the resultant solution for 30 minutes, AIBN (4.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 16. The obtained aqueous solution of the Copolymer 16 was found to have a viscosity of 2.5 mPa·s.

### Preparation of Copolymer 17

PMA (4.6 g), MPEGMA9 (41.4 g), and ethanol (154.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 17. The obtained aqueous solution of the Copolymer 17 was found to have a viscosity of 27.3 mPa·s.

### Preparation of Copolymer 18

PMA (9.0 g), MPEGMA9 (6.0 g), and ethanol (285.0 g) were charged into a 4-neck flask and stirred to thereby obtain a homogeneous solution. After nitrogen had been injected to the resultant solution for 30 minutes, AIBN (3.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 18. The obtained aqueous solution of the Copolymer 18 was found to have a viscosity of 2.9 mPa·s.

### Preparation of Copolymer 19

PMA (27.6 g), MPEGMA9 (18.4 g), and ethanol (154.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 19. The obtained aqueous solution of the Copolymer 19 was found to have a viscosity of 30.0 mPa·s.

### Preparation of Copolymer 20

PMA (6.4 g), MPEGMA9 (25.6 g), and ethanol (768.0 g) were charged into a 4-neck flask and stirred to thereby obtain a homogeneous solution. After nitrogen had been injected to the resultant solution for 30 minutes, AIBN (8.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 20. The obtained aqueous solution of the Copolymer 20 was found to have a viscosity of 1.8 mPa·s.

### Preparation of Copolymer 21

PMA (5.0 g), MPEGMA9 (45.0 g), and ethanol (150.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 21. The obtained aqueous solution of the Copolymer 21 was found to have a viscosity of 30.8 mPa·s.

### Preparation of Copolymer 22

PMA (7.2 g), MPEGMA9 (4.8 g), and ethanol (288.0 g) were charged into a 4-neck flask and stirred to thereby obtain a homogeneous solution. After nitrogen had been injected to the resultant solution for 30 minutes, AIBN (3.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 22. The obtained aqueous solution of the Copolymer 22 was found to have a viscosity of 1.6 mPa·s.

### Preparation of Copolymer 23

PMA (30.0 g), MPEGMA9 (20.0 g), and ethanol (150.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 23. The obtained aqueous solution of the Copolymer 23 was found to have a viscosity of 33.9 mPa·s.

### Preparation of Copolymer 24

PMA (1.6 g), MPEGMA9 (30.4 g), and ethanol (768.0 g) were charged into a 4-neck flask and stirred to thereby obtain a homogeneous solution. After nitrogen had been injected to the resultant solution for 30 minutes, AIBN (8.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 24. The obtained aqueous solution of the Copolymer 24 was found to have a viscosity of 1.3 mPa·s.

### Preparation of Copolymer 25

PMA (2.5 g), MPEGMA9 (47.5 g), and ethanol (150.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 25. The obtained aqueous solution of the Copolymer 25 was found to have a viscosity of 33.6 mPa·s.

### Preparation of Copolymer 26

PMA (9.6 g), MPEGMA9 (2.4 g), and ethanol (288.0 g) were charged into a 4-neck flask and stirred to thereby obtain a homogeneous solution. After nitrogen had been injected to the resultant solution for 30 minutes, AIBN (3.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 26. The obtained aqueous solution of the Copolymer 26 was found to have a viscosity of 1.6 mPa·s.

### Preparation of Copolymer 27

PMA (40.0 g), MPEGMA9 (10.0 g), and ethanol (150.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Copolymer 27. The obtained aqueous solution of the Copolymer 27 was found to have a viscosity of 34.8 mPa·s.

### Preparation of Copolymer 28

PMA (9.0 g), MPEGMA9 (21.0 g), and ethanol (170.0 g) were charged into a 4-neck flask and stirred to thereby obtain a homogeneous solution. After nitrogen had been injected to the resultant solution for 30 minutes, AIBN (2.0 g) was added thereto at 65° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide so that a neutralization rate was 40% and then purified through a dialysis membrane for 3 days. After purification, the concentration was accurately adjusted to 10% by mass to thereby obtain an aqueous solution of Copolymer 28. The obtained aqueous solution of the Copolymer 28 was found to have a viscosity of 5.6 mPa·s.

Copolymers of the Synthesis Examples are shown in Table 1-1 and Table 1-2.

TABLE 1-1

| | Structural units represented | | | Structural units represented | | | |
|---|---|---|---|---|---|---|---|
| | by General Formula (1) | | | by General Formula (2) | | | |
| | | Rate | Neutralized | | Rate | Neutralization | Viscosity |
| Copolymers | Monomers | (% by mass) | salts | Monomers | (% by mass) | Rate (%) | (mPa · s)* |
| Copolymer 1 | PMA | 30 | NaOH | MPEGMA9 | 70 | 100 | 13.9 |
| Copolymer 2 | PMA | 30 | NaOH | MPEGMA9 | 70 | 50 | 8.3 |
| Copolymer 3 | PMA | 30 | NaOH | MPEGA | 70 | 100 | 14.5 |
| Copolymer 4 | PMA | 30 | NaOH | EDEGA | 70 | 100 | 14.8 |
| Copolymer 5 | PMA | 30 | NaOH | BDEGMA | 70 | 100 | 14.9 |
| Copolymer 6 | PMA | 30 | NaOH | MTEGA | 70 | 100 | 12.9 |
| Copolymer 7 | PMA | 30 | NaOH | MPEGMA30 | 70 | 100 | 16.1 |
| Copolymer 8 | PMA | 30 | NaOH | MDPGMA | 70 | 100 | 13.8 |
| Copolymer 9 | PMA | 30 | KOH | MPEGMA9 | 70 | 100 | 14.0 |
| Copolymer 10 | PMA | 30 | LiOH | MPEGMA9 | 70 | 100 | 14.1 |
| Copolymer 11 | PMA | 30 | EA | MPEGMA9 | 70 | 100 | 13.5 |
| Copolymer 12 | PMA | 30 | DMEA | MPEGMA9 | 70 | 100 | 13.8 |
| Copolymer 13 | PA | 30 | NaOH | MPEGMA9 | 70 | 100 | 12.8 |
| Copolymer 14 | PPEGMA | 30 | NaOH | MPEGMA9 | 70 | 100 | 13.0 |

*Viscosity of an aqueous solution having a solid content of 10% by mass.

TABLE 1-2

| | Structural units represented | | | Structural units represented | | | |
|---|---|---|---|---|---|---|---|
| | by General Formula (1) | | | by General Formula (2) | | | |
| | | Rate | Neutralized | | Rate | Neutralization | Viscosity |
| Copolymers | Monomers | (% by mass) | salts | Monomers | (% by mass) | Rate (%) | (mPa · s)* |
| Copolymer 15 | PPPGMA | 30 | NaOH | MPEGMA9 | 70 | 100 | 13.1 |
| Copolymer 16 | PMA | 20 | NaOH | MPEGMA9 | 80 | 100 | 2.5 |
| Copolymer 17 | PMA | 10 | NaOH | MPEGMA9 | 90 | 100 | 27.3 |
| Copolymer 18 | PMA | 60 | NaOH | MPEGMA9 | 40 | 100 | 2.9 |
| Copolymer 19 | PMA | 60 | NaOH | MPEGMA9 | 40 | 100 | 30.0 |
| Copolymer 20 | PMA | 20 | NaOH | MPEGMA9 | 80 | 100 | 1.8 |
| Copolymer 21 | PMA | 10 | NaOH | MPEGMA9 | 90 | 100 | 30.8 |
| Copolymer 22 | PMA | 60 | NaOH | MPEGMA9 | 40 | 100 | 1.6 |
| Copolymer 23 | PMA | 60 | NaOH | MPEGMA9 | 40 | 100 | 33.9 |
| Copolymer 24 | PMA | 5 | NaOH | MPEGMA9 | 95 | 100 | 1.3 |
| Copolymer 25 | PMA | 5 | NaOH | MPEGMA9 | 95 | 100 | 33.6 |
| Copolymer 26 | PMA | 80 | NaOH | MPEGMA9 | 20 | 100 | 1.6 |
| Copolymer 27 | PMA | 80 | NaOH | MPEGMA9 | 20 | 100 | 34.8 |
| Copolymer 28 | PMA | 30 | NaOH | MPEGMA9 | 70 | 40 | 5.6 |

*Viscosity of an aqueous solution having a solid content of 10% by mass.

### Preparation of Pigment Dispersions

### Preparation Example 1

### Preparation of Pigment Dispersion 1

In accordance with the following Formulation (1), Carbon Black Pigment, copolymer, and pure water were pre-mixed together. Then, the resultant mixture was subjected to a circulation dispersion with a disk-type bead mill (product of SHINMARU ENTERPRISES corp., KDL-type, medium: zirconia ball in a diameter of 0.1 mm was used) at a circumferential speed of 10 m/s for 10 min to thereby obtain Pigment Dispersion 1.

### Formulation (1)

| | |
|---|---|
| Carbon Black Pigment, NIPEX150 | 16 parts by mass |
| (product of Degussa: gas black) | |
| Aqueous solution of Copolymer 1 | 40 parts by mass |
| (having a solid content of 10% by mass) | |
| Pure water | 44 parts by mass |

### Preparation Example 2

### Preparation of Pigment Dispersion 2

Pigment Dispersion 2 was obtained in the same manner as in Preparation Example 1 except that the formulation of Preparation Example 1 was changed to Formulation (2).

### Formulation (2)

| | |
|---|---|
| Carbon Black Pigment, NIPEX150 | 16 parts by mass |
| (product of Degussa: gas black) | |
| Aqueous solution of Copolymer 1 | 20 parts by mass |
| (having a solid content of 10% by mass) | |
| Pure water | 64 parts by mass |

### Preparation Example 3

### Preparation of Pigment Dispersion 3

Pigment Dispersion 3 was obtained in the same manner as in Preparation Example 1 except that the formulation of Preparation Example 1 was changed to Formulation (3).

### Formulation (3)

| | |
|---|---|
| Carbon Black Pigment, NIPEX150 | 16 parts by mass |
| (product of Degussa: gas black) | |
| Aqueous solution of Copolymer 1 | 80 parts by mass |
| (having a solid content of 10% by mass) | |
| Pure water | 4 parts by mass |

### Preparation Example 4

### Preparation of Pigment Dispersion 4

Pigment Dispersion 4 was obtained in the same manner as in Preparation Example 1 except that the formulation of Preparation Example 1 was changed to Formulation (4).

| | |
|---|---|
| Carbon Black Pigment, NIPEX150 | 16 parts by mass |
| (product of Degussa: gas black) | |
| Aqueous solution of Copolymer 1 | 80 parts by mass |
| (having a solid content of 20% by mass) | |
| Pure water | 4 parts by mass |

### Preparation Example 5

### Preparation of Pigment Dispersion 5

Pigment Dispersion 5 was obtained in the same manner as in Preparation Example 1 except that Carbon Black Pigment of Preparation Example 1 was changed to Pigment Blue 15:3.

### Preparation Example 6

### Preparation of Pigment Dispersion 6

Pigment Dispersion 6 was obtained in the same manner as in Preparation Example 1 except that Carbon Black Pigment of Preparation Example 1 was changed to Pigment Red 122.

### Preparation Example 7

### Preparation of Pigment Dispersion 7

Pigment Dispersion 7 was obtained in the same manner as in Preparation Example 1 except that Carbon Black Pigment of Preparation Example 1 was changed to Pigment Yellow 74.

### Preparation Examples 8-18

### Preparation of Pigment Dispersions 8-18

Pigment Dispersions 8-18 were obtained in the same manner as in Preparation Example 1 except that Carbon Black Pigment of Preparation Example 1 was changed to each of the aqueous solutions of Copolymers 2-18.

### Preparation Example 19

### Preparation of Pigment Dispersion 19

Pigment Dispersion 19 was obtained in the same manner as in Preparation Example 1 except that the aqueous solution of Copolymer 1 of Preparation Example 1 was changed to the aqueous solution of Copolymer 13.

### Preparation Example 20

### Preparation of Pigment Dispersion 20

Pigment Dispersion 20 was obtained in the same manner as in Preparation Example 19 except that Carbon Black Pigment of Preparation Example 19 was changed to Pigment Blue 15:3.

### Preparation Example 21

### Preparation of Pigment Dispersion 21

Pigment Dispersion 21 was obtained in the same manner as in Preparation Example 19 except that Carbon Black Pigment of Preparation Example 19 was changed to Pigment Red 122.

### Preparation Example 22

### Preparation of Pigment Dispersion 22

Pigment Dispersion 22 was obtained in the same manner as in Preparation Example 19 except that Carbon Black Pigment of Preparation Example 19 was changed to Pigment Yellow 74.

### Preparation Examples 23 to 36

### Preparation of Pigment Dispersions 23 to 36

Pigment Dispersions 23 to 36 were obtained in the same manner as in Preparation Example 1 except that the aqueous solution of Copolymer 1 of Preparation Example 1 was changed to each of the aqueous solutions of Copolymers 23 to 36.

### Preparation Example 37

### Preparation of Pigment Dispersion 37

Pigment Dispersion 37 was obtained in the same manner as in Preparation Example 1 except that the aqueous solution of Copolymer 1 of Preparation Example 1 was changed to the aqueous solution of Copolymer 28.

### Synthesis Examples of Comparative Copolymers

### Preparation of Comparative Copolymer 1

Into a 4-neck flask, maleic acid (100 g), styrene (100 g), water (500 g), and ammonium persulphate (15 g) were charged and stirred to thereby obtain a homogeneous solution. After nitrogen had been injected to the resultant solution for 30 minutes, AIBN (2.0 g) was added thereto at 80° C. to 90° C., and the resultant solution was allowed to undergo polymerization for 5 hours or longer. The solvent was removed from the obtained polymerized solution by an evaporator. While the resultant viscous matter was diluted with water, the concentration thereof was adjusted to about 10% by mass. The resultant mixture was neutralized with sodium hydroxide and then purified through a dialysis membrane for 3 days. After purification, the concentration was accurately adjusted to 10% by mass to thereby obtain an aqueous solution of Comparative Copolymer 1. The obtained aqueous solution of Comparative Copolymer 1 was found to have a viscosity of 13.5 mPa·s.

### Preparation of Comparative Copolymer 2

An aqueous solution of Comparative Copolymer 2 was obtained in the same manner as in Preparation of Comparative Copolymer 1 except that maleic acid and styrene in the preparation of Comparative Copolymer 1 were changed to PMA and styrene, respectively. The obtained aqueous solution of Comparative Copolymer 2 was found to have a viscosity of 14.4 mPa·s.

### Preparation of Comparative Copolymer 3

An aqueous solution of Comparative Copolymer 3 was obtained in the same manner as in Preparation of Comparative Copolymer 1 except that maleic acid and styrene in the preparation of Comparative Copolymer 1 were changed to maleic acid and MPEGMA9, respectively. The obtained aqueous solution of Comparative Copolymer 3 was found to have a viscosity of 14.1 mPa·s. Copolymers of Comparative Synthesis Examples are shown in Table 2.

TABLE 2

| | Structural units represented | | | Structural units represented | | | |
|---|---|---|---|---|---|---|---|
| | by General Formula (1) | | | by General Formula (2) | | | |
| | | Rate | Neutralized | | Rate | Neutralization | Viscosity |
| Copolymers | Monomers | (% by mass) | salts | Monomers | (% by mass) | Rate (%) | (mPa · s)* |

| Comparative | Maleic acid | | NaOH | Styrene | 100 | 13.5 |
|---|---|---|---|---|---|---|
| Copolymer 1 | | | | | | |
| Comparative | PMA | 50 | NaOH | Styrene | 100 | 14.4 |
| Copolymer 2 | | | | | | |

| | | | | | | |
|---|---|---|---|---|---|---|
| Comparative | Maleic acid | NaOH | MPEGMA9 | 50 | 100 | 14.1 |
| Copolymer 3 | | | | | | |

*Viscosity of an aqueous solution having a solid content of 10% by mass.

### Preparation of Pigment Dispersions

### Comparative Preparation Example 1

### Preparation of Comparative Pigment Dispersion 1

Comparative Pigment Dispersion 1 was obtained in the same manner as in Preparation Example 1 except that the aqueous solution of Copolymer 1 of Preparation Example 1 was changed to the aqueous solution of Comparative Copolymer 1.

### Comparative Preparation Example 2

### Preparation of Comparative Pigment Dispersion 2

Comparative Pigment Dispersion 2 was obtained in the same manner as in Comparative Preparation Example 1 except that carbon black pigment of Comparative Preparation Example 1 was changed to Pigment Blue 15:3.

### Comparative Preparation Example 3

### Preparation of Comparative Pigment Dispersion 3

Comparative Pigment Dispersion 3 was obtained in the same manner as in Comparative Preparation Example 1 except that carbon black pigment of Comparative Preparation Example 1 was changed to Pigment Red 122.

### Comparative Preparation Example 4

### Preparation of Comparative Pigment Dispersion 4

Comparative Pigment Dispersion 4 was obtained in the same manner as in Comparative Preparation Example 1 except that carbon black pigment of Comparative Preparation Example 1 was changed to Pigment Yellow 74.

### Comparative Preparation Example 5

### Preparation of Comparative Pigment Dispersion 5

Comparative Pigment Dispersion 5 was obtained in the same manner as in Comparative Preparation Example 1 except that the aqueous solution of Comparative Copolymer 1 of Comparative Preparation Example 1 was changed to the aqueous solution of Comparative Copolymer 2.

### Comparative Preparation Example 6

### Preparation of Comparative Pigment Dispersion 6

Comparative Pigment Dispersion 6 was obtained in the same manner as in Comparative Preparation Example 1 except that the aqueous solution of Comparative Copolymer 1 of Comparative Preparation Example 1 was changed to the aqueous solution of Comparative Copolymer 3.

### Examples 1 to 49, Comparative Examples 1 to 6

### Method for Producing Inkjet Ink

### Example 1

The materials in accordance with the following formulation were mixed and stirred for 30 minutes to thereby prepare an ink.

| | | |
|---|---|---|
| Pigment Dispersion 1 of Preparation Example 1 | 50.0 | parts by mass |
| (pigment concentration of 16% by mass) | | |
| 1,3-Butanediol | 15.0 | parts by mass |
| Glycerin | 20.0 | parts by mass |
| 2-Ethyl-1,3-hexanediol | 1.0 | part by mass |
| 2,2,4-Trimethyl-1,3-pentanediol | 1.0 | part by mass |
| FS-300: polyoxyethyleneperfluoroalkylether | 2.5 | parts by mass |
| (Product of Du Pont, ingredient of 40% by mass) | | |
| Pure water | 10.5 | parts by mass |

### Examples 2 to 4

Inks of Examples 2 to 4 were obtained in the same manner as in Example 1 except that Pigment Dispersion of Example 1 was changed to each of Pigment Dispersions 2 to 4.

### Example 5

The materials in accordance with the following formulations were mixed and stirred for 30 minutes to thereby prepare an ink.

| | | |
|---|---|---|
| Pigment Dispersion 1 of Preparation Example 1 | 50.0 | parts by mass |
| (pigment concentration of 16% by mass) | | |
| 1,3-Butanediol | 15.0 | parts by mass |
| Glycerin | 20.0 | parts by mass |
| 2-Ethyl-1,3-hexanediol | 1.0 | part by mass |
| 2,2,4-Trimethyl-1,3-pentanediol | 1.0 | part by mass |
| FS-300: polyoxyethyleneperfluoroalkylether | 2.5 | parts by mass |
| (product of Dupont, ingredient of 40% by mass) | | |
| Acrylic-silicone resin emulsion: | 6.0 | parts by mass |
| (POLYSOL ROY6312, product of Showa | | |
| Denko K.K.) | | |
| Pure water | 4.5 | parts by mass |

### Example 6

The materials in accordance with the following formulations were mixed and stirred for 30 minutes to thereby prepare an ink.

| | | |
|---|---|---|
| Pigment Dispersion 5 of Preparation Example 5 | 40.0 | parts by mass |
| (pigment concentration of 16% by mass) | | |
| 1,3-Butanediol | 15.0 | parts by mass |
| Glycerin | 20.0 | parts by mass |
| 2-Ethyl-1,3-hexanediol | 2.0 | parts by mass |
| Fluorine-containing surfactant (KF-643) | 1.0 | part by mass |
| FS-300: polyoxyethyleneperfluoroalkylether | 2.5 | parts by mass |
| (product of Dupont, ingredient of 40% by mass) | | |
| Pure water | 19.5 | parts by mass |

### Example 7

The materials in accordance with the following formulations were mixed and stirred for 30 minutes to thereby prepare an ink.

| | | |
|---|---|---|
| Pigment Dispersion 6 of Preparation Example 6 | 40.0 | parts by mass |
| (pigment concentration of 16% by mass) | | |
| 1,3-Butanediol | 15.0 | parts by mass |
| Glycerin | 20.0 | parts by mass |
| 2-Ethyl-1,3-hexanediol | 2.0 | parts by mass |
| Fluorine-containing surfactant (KF-643) | 1.0 | part by mass |
| FS-300: polyoxyethyleneperfluoroalkylether | 2.5 | parts by mass |
| (product of Dupont, ingredient of 40% by mass) | | |
| Pure water | 19.5 | parts by mass |

### Example 8

The materials in accordance with the following formulations were mixed and stirred for 30 minutes to thereby prepare an ink.

| | | |
|---|---|---|
| Pigment Dispersion 7 of Preparation Example 7 | 40.0 | parts by mass |
| (pigment concentration of 16% by mass) | | |
| 1,3-Butanediol | 15.0 | parts by mass |
| Glycerin | 20.0 | parts by mass |
| 2-Ethyl-1,3-hexanediol | 2.0 | parts by mass |
| FS-300: polyoxyethyleneperfluoroalkylether | 2.5 | parts by mass |
| (product of Dupont, ingredient of 40% by mass) | | |
| Pure water | 19.5 | parts by mass |

### Examples 9 to 20

Inks of Examples 9 to 20 were obtained in the same manner as in Example 1 except that Pigment Dispersion of Example 1 was changed to each of Pigment Dispersions 8 to 19.

### Examples 21 to 24

Inks of Examples 21 to 24 were obtained in the same manner as in Example 1 except that Pigment Dispersions 1, 5, 6, and 7, each of which was used in Examples 5 to 8 were changed to Pigment Dispersions 19-22, respectively.

### Examples 25 to 39

Inks of Examples 25 to 39 were obtained in the same manner as in Example 1 except that Pigment Dispersion of Example 1 was changed to Pigment Dispersions 23 to 37, respectively.

### Example 40

The materials in accordance with the following formulations were mixed and stirred for 30 minutes to thereby prepare an ink.

| | | |
|---|---|---|
| Pigment Dispersion 1 of Preparation Example 1 | 50.0 | parts by mass |
| (pigment concentration of 16% by mass) | | |
| 1,3-Butanediol | 35.0 | parts by mass |
| 2-Ethyl-1,3-hexanediol | 1.0 | part by mass |
| 2,2,4-Trimethyl-1,3-pentanediol | 1.0 | part by mass |
| FS-300: polyoxyethyleneperfluoroalkylether | 2.5 | parts by mass |
| (product of Dupont, ingredient of 40% by mass) | | |
| Pure water | 10.5 | parts by mass |

### Example 41

The materials in accordance with the following formulations were mixed and stirred for 30 minutes to thereby prepare an ink.

| | | |
|---|---|---|
| Pigment Dispersion 18 of Preparation Example 18 | 50.0 | parts by mass |
| (pigment concentration of 16% by mass) | | |
| 1,3-Butanediol | 35.0 | parts by mass |
| 2-Ethyl-1,3-hexanediol | 1.0 | part by mass |
| 2,2,4-Trimethyl-1,3-pentanediol | 1.0 | part by mass |
| FS-300: polyoxyethyleneperfluoroalkylether | 2.5 | parts by mass |
| (product of Dupont, ingredient of 40% by mass | | |
| by mass) | | |
| Pure water | 10.5 | parts by mass |

### Example 42

The materials in accordance with the following formulations were mixed and stirred for 30 minutes to thereby prepare an ink.

| | | |
|---|---|---|
| Pigment Dispersion 19 of Preparation Example 19 | 50.0 | parts by mass |
| (pigment concentration of 16% by mass) | | |
| 1,3-Butanediol | 35.0 | parts by mass |
| 2-Ethyl-1,3-hexanediol | 1.0 | part by mass |
| 2,2,4-Trimethyl-1,3-pentanediol | 1.0 | part by mass |
| FS-300: polyoxyethyleneperfluoroalkylether | 2.5 | parts by mass |
| (product of Dupont, ingredient of 40% by mass | | |
| by mass) | | |
| Pure water | 10.5 | parts by mass |

### Example 43

### Preparation of Inkjet Recording Ink by Addition of Copolymer

The materials in accordance with the following formulations were mixed and stirred for 30 minutes to thereby prepare an ink.

| | | |
|---|---|---|
| Comparative Pigment Dispersion 1 of | 50.0 | parts by mass |
| Comparative Preparation Example 1 | | |
| (pigment concentration of 16% by mass) | | |
| Copolymer 1 | 0.5 | parts by mass |
| 1,3-Butanediol | 15.0 | parts by mass |
| Glycerin | 20.0 | parts by mass |
| 2-Ethyl-1,3-hexanediol | 1.0 | part by mass |
| 2,2,4-Trimethyl-1,3-pentanediol | 1.0 | part by mass |
| Polyoxyethyleneperfluoroalkylether | 2.5 | parts by mass |
| (FS-300, product of Dupont, | | |
| ingredient of 40% by mass by mass) | | |
| Pure water | 10.0 | parts by mass |

### Example 44

### Preparation of Inkjet Recording Ink by Addition of Copolymer

An inkjet recording ink of Example 44 was obtained in the same manner as in Example 43, except that the amount of Copolymer 1 of Example 43 was changed to 2.0 parts by mass from 0.5 parts by mass, and the amount of pure water was changed to 8.5 parts by mass from 10.0 parts by mass.

### Example 45

### Preparation of Inkjet Recording Ink by Addition of Copolymer

An inkjet recording ink of Example 45 was obtained in the same manner as in Example 43, except that the amount of Copolymer 1 of Example 43 was changed to 5.0 parts by mass from 0.5 parts by mass, and the amount of pure water was changed to 5.5 parts by mass from 10.0 parts by mass.

### Example 46

### Preparation of Inkjet Recording Ink by Addition of Copolymer

An inkjet recording ink of Example 46 was obtained in the same manner as in Example 43, except that the amount of Copolymer 1 of Example 43 was changed to 10.0 parts by mass from 0.5 parts by mass, and the amount of pure water was changed to 0.5 parts by mass from 10.0 parts by mass.

### Example 47

### Preparation of Ink by Addition of Copolymer

The materials in accordance with the following formulations were mixed and stirred for 30 minutes to thereby prepare an ink.

| | | |
|---|---|---|
| Comparative Pigment Dispersion 2 of | 40.0 | parts by mass |
| Comparative Preparation Example 2 | | |
| (pigment concentration of 16% by mass) | | |
| Copolymer 1 | 2.0 | parts by mass |
| 1,3-Butanediol | 15.0 | parts by mass |
| Glycerin | 20.0 | parts by mass |
| 2-Ethyl-1,3-hexanediol | 2.0 | parts by mass |
| Polyoxyethyleneperfluoroalkylether | 2.5 | parts by mass |
| (FS-300, product of Dupont, | | |
| ingredient of 40% by mass by mass) | | |
| Fluorine-containing surfactant (KF-643) | 1 | part by mass |
| Pure water | 17.5 | parts by mass |

### Example 48

### Preparation of Ink by Addition of Copolymer

An inkjet recording ink of Example 48 was obtained in the same manner as in Example 47, except that Comparative Pigment Dispersion 2 of Example 47 was changed to Comparative Pigment Dispersion 3.

### Example 49

### Preparation of Ink by Addition of Copolymer

An inkjet recording ink of Example 49 was obtained in the same manner as in Example 47, except that Comparative Pigment Dispersion 2 of Example 47 was changed to Comparative Pigment Dispersion 4.

### Comparative Example 1

An ink of Comparative Example 1 was obtained in the same manner as in Example 1 except that Pigment Dispersion 1 of Example 1 was changed to Comparative Pigment Dispersion 1.

### Comparative Example 2

An ink of Comparative Example 2 was obtained in the same manner as in Example 6 except that Pigment Dispersion 5 of Example 6 was changed to Comparative Pigment Dispersion 2.

### Comparative Example 3

An ink of Comparative Example 3 was obtained in the same manner as in Example 7 except that Pigment Dispersion 6 of Example 7 was changed to Comparative Pigment Dispersion 3.

### Comparative Example 4

An ink of Comparative Example 4 was obtained in the same manner as in Example 8 except that Pigment Dispersion 7 of Example 8 was changed to Comparative Pigment Dispersion 4.

### Comparative Example 5

An ink of Comparative Example 5 was obtained in the same manner as in Example 1 except that Pigment Dispersion 1 of Example 1 was changed to Comparative Pigment Dispersion 5.

### Comparative Example 6

An ink of Comparative Example 6 was obtained in the same manner as in Example 1 except that Pigment Dispersion 1 of Example 1 was changed to Comparative Pigment Dispersion 6.

Tables 3-1, 3-2, 4-1, 4-2, 5-1, and 5-2 show Examples where the copolymers were used as a dispersing agent. Table 6 shows Examples where the copolymers were used as an additive. Table 7 shows Comparative Examples. Note that, each of the components described in Tables 3-1, 3-2, 4-1, 4-2, 5-1, 5-2, 6 and 7 denotes “parts by mass”.

TABLE 3-1

| | | Ex. 1 | Ex. 2 | Ex. 3 | Ex. 4 | Ex. 5 | Ex. 6 | Ex. 7 |
|---|---|---|---|---|---|---|---|---|
| Pigment | Pigment Dispersion 1 | 50 | | | | 50 | | |
| Dispersions | Pigment Dispersion 2 | | 50 | | | | | |
| | Pigment Dispersion 3 | | | 50 | | | | |
| | Pigment Dispersion 4 | | | | 50 | | | |
| | Pigment Dispersion 5 | | | | | | 40 | |
| | Pigment Dispersion 6 | | | | | | | 40 |
| | Pigment Dispersion 7 | | | | | | | |
| | Pigment Dispersion 8 | | | | | | | |
| | Pigment Dispersion 9 | | | | | | | |
| | Pigment Dispersion 10 | | | | | | | |
| | Pigment Dispersion 11 | | | | | | | |
| | Pigment Dispersion 12 | | | | | | | |
| | Pigment Dispersion 13 | | | | | | | |
| | Pigment Dispersion 14 | | | | | | | |
| | Pigment Dispersion 15 | | | | | | | |
| | Pigment Dispersion 16 | | | | | | | |
| | Pigment Dispersion 17 | | | | | | | |
| | Pigment Dispersion 18 | | | | | | | |
| | Pigment Dispersion 19 | | | | | | | |
| | Pigment Dispersion 20 | | | | | | | |
| | Pigment Dispersion 21 | | | | | | | |
| | Pigment Dispersion 22 | | | | | | | |
| | Pigment Dispersion 23 | | | | | | | |
| | Pigment Dispersion 24 | | | | | | | |
| | Pigment Dispersion 25 | | | | | | | |
| | Pigment Dispersion 26 | | | | | | | |
| | Pigment Dispersion 27 | | | | | | | |
| | Pigment Dispersion 28 | | | | | | | |
| | Pigment Dispersion 29 | | | | | | | |
| | Pigment Dispersion 30 | | | | | | | |
| | Pigment Dispersion 31 | | | | | | | |
| | Pigment Dispersion 32 | | | | | | | |
| | Pigment Dispersion 33 | | | | | | | |
| | Pigment Dispersion 34 | | | | | | | |
| | Pigment Dispersion 35 | | | | | | | |
| | Pigment Dispersion 36 | | | | | | | |
| | Pigment Dispersion 37 | | | | | | | |
| Water-soluble | 1,3-butanediol | 15 | 15 | 15 | 15 | 15 | 15 | 15 |
| solvents | Glycerin | 20 | 20 | 20 | 20 | 20 | 20 | 20 |
| | 2-ethyl-1,3-hexanediol | 1 | 1 | 1 | 1 | 1 | 2 | 2 |
| | 2,2,4-trimethyl-1,3-pentanediol | 1 | 1 | 1 | 1 | 1 | 0 | 0 |
| Surfactants | FS-300 | 2.5 | 2.5 | 2.5 | 2.5 | 2.5 | 2.5 | 2.5 |
| | KF-643 | 0 | 0 | 0 | 0 | 0 | 1 | 1 |
| Water-soluble | Polyurethane | 0 | 0 | 0 | 0 | 6 | 0 | 0 |
| resins | emulsion | | | | | | | |
| Pure water | Pure water | 10.5 | 10.5 | 10.5 | 10.5 | 4.5 | 19.5 | 19.5 |

| | | | | | | | |
|---|---|---|---|---|---|---|---|
| Total | 100 | 100 | 100 | 100 | 100 | 100 | 100 |

TABLE 3-2

| | | Ex. 8 | Ex. 9 | Ex. 10 | Ex. 11 | Ex. 12 | Ex. 13 |
|---|---|---|---|---|---|---|---|
| Pigment | Pigment Dispersion 1 | | | | | | |
| Dispersions | Pigment Dispersion 2 | | | | | | |
| | Pigment Dispersion 3 | | | | | | |
| | Pigment Dispersion 4 | | | | | | |
| | Pigment Dispersion 5 | | | | | | |
| | Pigment Dispersion 6 | | | | | | |
| | Pigment Dispersion 7 | 40 | | | | | |
| | Pigment Dispersion 8 | | 50 | | | | |
| | Pigment Dispersion 9 | | | 50 | | | |
| | Pigment Dispersion 10 | | | | 50 | | |
| | Pigment Dispersion 11 | | | | | 50 | |
| | Pigment Dispersion 12 | | | | | | 50 |
| | Pigment Dispersion 13 | | | | | | |
| | Pigment Dispersion 14 | | | | | | |
| | Pigment Dispersion 15 | | | | | | |
| | Pigment Dispersion 16 | | | | | | |
| | Pigment Dispersion 17 | | | | | | |
| | Pigment Dispersion 18 | | | | | | |
| | Pigment Dispersion 19 | | | | | | |
| | Pigment Dispersion 20 | | | | | | |
| | Pigment Dispersion 21 | | | | | | |
| | Pigment Dispersion 22 | | | | | | |
| | Pigment Dispersion 23 | | | | | | |
| | Pigment Dispersion 24 | | | | | | |
| | Pigment Dispersion 25 | | | | | | |
| | Pigment Dispersion 26 | | | | | | |
| | Pigment Dispersion 27 | | | | | | |
| | Pigment Dispersion 28 | | | | | | |
| | Pigment Dispersion 29 | | | | | | |
| | Pigment Dispersion 30 | | | | | | |
| | Pigment Dispersion 31 | | | | | | |
| | Pigment Dispersion 32 | | | | | | |
| | Pigment Dispersion 33 | | | | | | |
| | Pigment Dispersion 34 | | | | | | |
| | Pigment Dispersion 35 | | | | | | |
| | Pigment Dispersion 36 | | | | | | |
| | Pigment Dispersion 37 | | | | | | |
| Water-soluble | 1,3-butanediol | 15 | 15 | 15 | 15 | 15 | 15 |
| solvents | Glycerin | 20 | 20 | 20 | 20 | 20 | 20 |
| | 2-ethyl-1,3-hexanediol | 2 | 1 | 1 | 1 | 1 | 1 |
| | 2,2,4-trimethyl-1,3-pentanediol | 0 | 1 | 1 | 1 | 1 | 1 |
| Surfactants | FS-300 | 2.5 | 2.5 | 2.5 | 2.5 | 2.5 | 2.5 |
| | KF-643 | 1 | 0 | 0 | 0 | 0 | 0 |
| Water-soluble | Polyurethane | 0 | 0 | 0 | 0 | 0 | 0 |
| resins | emulsion | | | | | | |
| Pure water | Pure water | 19.5 | 10.5 | 10.5 | 10.5 | 10.5 | 10.5 |

| | | | | | | |
|---|---|---|---|---|---|---|
| Total | 100 | 100 | 100 | 100 | 100 | 100 |

TABLE 4-1

| | | Ex. 14 | Ex. 15 | Ex. 16 | Ex. 17 | Ex. 18 | Ex. 19 | Ex. 20 |
|---|---|---|---|---|---|---|---|---|
| Pigment | Pigment Dispersion 1 | | | | | | | |
| Dispersions | Pigment Dispersion 2 | | | | | | | |
| | Pigment Dispersion 3 | | | | | | | |
| | Pigment Dispersion 4 | | | | | | | |
| | Pigment Dispersion 5 | | | | | | | |
| | Pigment Dispersion 6 | | | | | | | |
| | Pigment Dispersion 7 | | | | | | | |
| | Pigment Dispersion 8 | | | | | | | |
| | Pigment Dispersion 9 | | | | | | | |
| | Pigment Dispersion 10 | | | | | | | |
| | Pigment Dispersion 11 | | | | | | | |
| | Pigment Dispersion 12 | | | | | | | |
| | Pigment Dispersion 13 | 50 | | | | | | |
| | Pigment Dispersion 14 | | 50 | | | | | |
| | Pigment Dispersion 15 | | | 50 | | | | |
| | Pigment Dispersion 16 | | | | 50 | | | |
| | Pigment Dispersion 17 | | | | | 50 | | |
| | Pigment Dispersion 18 | | | | | | 50 | |
| | Pigment Dispersion 19 | | | | | | | 50 |
| | Pigment Dispersion 20 | | | | | | | |
| | Pigment Dispersion 21 | | | | | | | |
| | Pigment Dispersion 22 | | | | | | | |
| | Pigment Dispersion 23 | | | | | | | |
| | Pigment Dispersion 24 | | | | | | | |
| | Pigment Dispersion 25 | | | | | | | |
| | Pigment Dispersion 26 | | | | | | | |
| | Pigment Dispersion 27 | | | | | | | |
| | Pigment Dispersion 28 | | | | | | | |
| | Pigment Dispersion 29 | | | | | | | |
| | Pigment Dispersion 30 | | | | | | | |
| | Pigment Dispersion 31 | | | | | | | |
| | Pigment Dispersion 32 | | | | | | | |
| | Pigment Dispersion 33 | | | | | | | |
| | Pigment Dispersion 34 | | | | | | | |
| | Pigment Dispersion 35 | | | | | | | |
| | Pigment Dispersion 36 | | | | | | | |
| | Pigment Dispersion 37 | | | | | | | |
| Water-soluble | 1,3-butanediol | 15 | 15 | 15 | 15 | 15 | 15 | 15 |
| solvents | Glycerin | 20 | 20 | 20 | 20 | 20 | 20 | 20 |
| | 2-ethyl-1,3-hexanediol | 1 | 1 | 1 | 1 | 1 | 1 | 1 |
| | 2,2,4-trimethyl-1,3-pentanediol | 1 | 1 | 1 | 1 | 1 | 1 | 1 |
| Surfactants | FS-300 | 2.5 | 2.5 | 2.5 | 2.5 | 2.5 | 2.5 | 2.5 |
| | KF-643 | 0 | 0 | 0 | 0 | 0 | 0 | 0 |
| Water-soluble | Polyurethane emulsion | 0 | 0 | 0 | 0 | 0 | 0 | 0 |
| resins | | | | | | | | |
| Pure water | Pure water | 10.5 | 10.5 | 10.5 | 10.5 | 10.5 | 10.5 | 10.5 |

| | | | | | | | |
|---|---|---|---|---|---|---|---|
| Total | 100 | 100 | 100 | 100 | 100 | 100 | 100 |

TABLE 4-2

| | | Ex. 21 | Ex. 22 | Ex. 23 | Ex. 24 | Ex. 25 | Ex. 26 |
|---|---|---|---|---|---|---|---|
| Pigment | Pigment Dispersion 1 | | | | | | |
| Dispersions | Pigment Dispersion 2 | | | | | | |
| | Pigment Dispersion 3 | | | | | | |
| | Pigment Dispersion 4 | | | | | | |
| | Pigment Dispersion 5 | | | | | | |
| | Pigment Dispersion 6 | | | | | | |
| | Pigment Dispersion 7 | | | | | | |
| | Pigment Dispersion 8 | | | | | | |
| | Pigment Dispersion 9 | | | | | | |
| | Pigment Dispersion 10 | | | | | | |
| | Pigment Dispersion 11 | | | | | | |
| | Pigment Dispersion 12 | | | | | | |
| | Pigment Dispersion 13 | | | | | | |
| | Pigment Dispersion 14 | | | | | | |
| | Pigment Dispersion 15 | | | | | | |
| | Pigment Dispersion 16 | | | | | | |
| | Pigment Dispersion 17 | | | | | | |
| | Pigment Dispersion 18 | | | | | | |
| | Pigment Dispersion 19 | 50 | | | | | |
| | Pigment Dispersion 20 | | 40 | | | | |
| | Pigment Dispersion 21 | | | 40 | | | |
| | Pigment Dispersion 22 | | | | 40 | | |
| | Pigment Dispersion 23 | | | | | 50 | |
| | Pigment Dispersion 24 | | | | | | 50 |
| | Pigment Dispersion 25 | | | | | | |
| | Pigment Dispersion 26 | | | | | | |
| | Pigment Dispersion 27 | | | | | | |
| | Pigment Dispersion 28 | | | | | | |
| | Pigment Dispersion 29 | | | | | | |
| | Pigment Dispersion 30 | | | | | | |
| | Pigment Dispersion 31 | | | | | | |
| | Pigment Dispersion 32 | | | | | | |
| | Pigment Dispersion 33 | | | | | | |
| | Pigment Dispersion 34 | | | | | | |
| | Pigment Dispersion 35 | | | | | | |
| | Pigment Dispersion 36 | | | | | | |
| | Pigment Dispersion 37 | | | | | | |
| Water-soluble | 1,3-butanediol | 15 | 15 | 15 | 15 | 15 | 15 |
| solvents | Glycerin | 20 | 20 | 20 | 20 | 20 | 20 |
| | 2-ethyl-1,3-hexanediol | 1 | 2 | 2 | 2 | 1 | 1 |
| | 2,2,4-trimethyl-1,3-pentanediol | 1 | 0 | 0 | 0 | 1 | 1 |
| Surfactants | FS-300 | 2.5 | 2.5 | 2.5 | 2.5 | 2.5 | 2.5 |
| | KF-643 | 0 | 1 | 1 | 1 | 0 | 0 |
| Water-soluble | Polyurethane | 6 | 0 | 0 | 0 | 0 | 0 |
| resins | emulsion | | | | | | |
| Pure water | Pure water | 4.5 | 19.5 | 19.5 | 19.5 | 10.5 | 10.5 |

| | | | | | | |
|---|---|---|---|---|---|---|
| Total | 100 | 100 | 100 | 100 | 100 | 100 |

TABLE 5-1

| | | Ex. 27 | Ex. 28 | Ex. 29 | Ex. 30 | Ex. 31 | Ex. 32 | Ex. 33 | Ex. 34 |
|---|---|---|---|---|---|---|---|---|---|
| Pigment | Pigment Dispersion 1 | | | | | | | | |
| Dispersions | Pigment Dispersion 2 | | | | | | | | |
| | Pigment Dispersion 3 | | | | | | | | |
| | Pigment Dispersion 4 | | | | | | | | |
| | Pigment Dispersion 5 | | | | | | | | |
| | Pigment Dispersion 6 | | | | | | | | |
| | Pigment Dispersion 7 | | | | | | | | |
| | Pigment Dispersion 8 | | | | | | | | |
| | Pigment Dispersion 9 | | | | | | | | |
| | Pigment Dispersion 10 | | | | | | | | |
| | Pigment Dispersion 11 | | | | | | | | |
| | Pigment Dispersion 12 | | | | | | | | |
| | Pigment Dispersion 13 | | | | | | | | |
| | Pigment Dispersion 14 | | | | | | | | |
| | Pigment Dispersion 15 | | | | | | | | |
| | Pigment Dispersion 16 | | | | | | | | |
| | Pigment Dispersion 17 | | | | | | | | |
| | Pigment Dispersion 18 | | | | | | | | |
| | Pigment Dispersion 19 | | | | | | | | |
| | Pigment Dispersion 20 | | | | | | | | |
| | Pigment Dispersion 21 | | | | | | | | |
| | Pigment Dispersion 22 | | | | | | | | |
| | Pigment Dispersion 23 | | | | | | | | |
| | Pigment Dispersion 24 | | | | | | | | |
| | Pigment Dispersion 25 | 50 | | | | | | | |
| | Pigment Dispersion 26 | | 50 | | | | | | |
| | Pigment Dispersion 27 | | | 50 | | | | | |
| | Pigment Dispersion 28 | | | | 50 | | | | |
| | Pigment Dispersion 29 | | | | | 50 | | | |
| | Pigment Dispersion 30 | | | | | | 50 | | |
| | Pigment Dispersion 31 | | | | | | | 50 | |
| | Pigment Dispersion 32 | | | | | | | | 50 |
| | Pigment Dispersion 33 | | | | | | | | |
| | Pigment Dispersion 34 | | | | | | | | |
| | Pigment Dispersion 35 | | | | | | | | |
| | Pigment Dispersion 36 | | | | | | | | |
| | Pigment Dispersion 37 | | | | | | | | |
| Water-soluble | 1,3-butanediol | 15 | 15 | 15 | 15 | 15 | 15 | 15 | 15 |
| solvents | Glycerin | 20 | 20 | 20 | 20 | 20 | 20 | 20 | 20 |
| | 2-ethyl-1,3-hexanediol | 1 | 1 | 1 | 1 | 1 | 1 | 1 | 1 |
| | 2,2,4-trimethyl-1,3-pentanediol | 1 | 1 | 1 | 1 | 1 | 1 | 1 | 1 |
| Surfactants | FS-300 | 2.5 | 2.5 | 2.5 | 2.5 | 2.5 | 2.5 | 2.5 | 2.5 |
| | KF-643 | 0 | 0 | 0 | 0 | 0 | 0 | 0 | 0 |
| Water-soluble | Polyurethane | 0 | 0 | 0 | 0 | 0 | 0 | 0 | 0 |
| resins | emulsion | | | | | | | | |
| Pure water | Pure water | 10.5 | 10.5 | 10.5 | 10.5 | 10.5 | 10.5 | 10.5 | 10.5 |

| | | | | | | | | |
|---|---|---|---|---|---|---|---|---|
| Total | 100 | 100 | 100 | 100 | 100 | 100 | 100 | 100 |

TABLE 5-2

| | | Ex. 35 | Ex. 36 | Ex. 37 | Ex. 38 | Ex. 39 | Ex. 40 | Ex. 41 | Ex. 42 |
|---|---|---|---|---|---|---|---|---|---|
| Pigment | Pigment Dispersion 1 | | | | | | 50 | | |
| Dispersions | Pigment Dispersion 2 | | | | | | | | |
| | Pigment Dispersion 3 | | | | | | | | |
| | Pigment Dispersion 4 | | | | | | | | |
| | Pigment Dispersion 5 | | | | | | | | |
| | Pigment Dispersion 6 | | | | | | | | |
| | Pigment Dispersion 7 | | | | | | | | |
| | Pigment Dispersion 8 | | | | | | | | |
| | Pigment Dispersion 9 | | | | | | | | |
| | Pigment Dispersion 10 | | | | | | | | |
| | Pigment Dispersion 11 | | | | | | | | |
| | Pigment Dispersion 12 | | | | | | | | |
| | Pigment Dispersion 13 | | | | | | | | |
| | Pigment Dispersion 14 | | | | | | | | |
| | Pigment Dispersion 15 | | | | | | | | |
| | Pigment Dispersion 16 | | | | | | | | |
| | Pigment Dispersion 17 | | | | | | | | |
| | Pigment Dispersion 18 | | | | | | | 50 | |
| | Pigment Dispersion 19 | | | | | | | | 50 |
| | Pigment Dispersion 20 | | | | | | | | |
| | Pigment Dispersion 21 | | | | | | | | |
| | Pigment Dispersion 22 | | | | | | | | |
| | Pigment Dispersion 23 | | | | | | | | |
| | Pigment Dispersion 24 | | | | | | | | |
| | Pigment Dispersion 25 | | | | | | | | |
| | Pigment Dispersion 26 | | | | | | | | |
| | Pigment Dispersion 27 | | | | | | | | |
| | Pigment Dispersion 28 | | | | | | | | |
| | Pigment Dispersion 29 | | | | | | | | |
| | Pigment Dispersion 30 | | | | | | | | |
| | Pigment Dispersion 31 | | | | | | | | |
| | Pigment Dispersion 32 | | | | | | | | |
| | Pigment Dispersion 33 | 50 | | | | | | | |
| | Pigment Dispersion 34 | | 50 | | | | | | |
| | Pigment Dispersion 35 | | | 50 | | | | | |
| | Pigment Dispersion 36 | | | | 50 | | | | |
| | Pigment Dispersion 37 | | | | | 50 | | | |
| Water-soluble | 1,3-butanediol | 15 | 15 | 15 | 15 | 15 | 35 | 35 | 35 |
| solvents | Glycerin | 20 | 20 | 20 | 20 | 20 | 0 | 0 | 0 |
| | 2-ethyl-1,3-hexanediol | 1 | 1 | 1 | 1 | 1 | 1 | 1 | 1 |
| | 2,2,4-trimethyl-1,3-pentanediol | 1 | 1 | 1 | 1 | 1 | 1 | 1 | 1 |
| Surfactants | FS-300 | 2.5 | 2.5 | 2.5 | 2.5 | 2.5 | 2.5 | 2.5 | 2.5 |
| | KF-643 | 0 | 0 | 0 | 0 | 0 | 0 | 0 | 0 |
| Water-soluble | Polyurethane | 0 | 0 | 0 | 0 | 0 | 0 | 0 | 0 |
| resins | emulsion | | | | | | | | |
| Pure water | Pure water | 10.5 | 10.5 | 10.5 | 10.5 | 10.5 | 10.5 | 10.5 | 10.5 |

| | | | | | | | | |
|---|---|---|---|---|---|---|---|---|
| Total | 100 | 100 | 100 | 100 | 100 | 100 | 100 | 100 |

TABLE 6

| | | Ex. 43 | Ex. 44 | Ex. 45 | Ex. 46 | Ex. 47 | Ex. 48 | Ex. 49 |
|---|---|---|---|---|---|---|---|---|
| Pigment | Comparative | 50 | 50 | 50 | 50 | | | |
| Dispersions | Pigment Dispersion 1 | | | | | | | |
| | Comparative | | | | | 40 | | |
| | Pigment Dispersion 2 | | | | | | | |
| | Comparative | | | | | | 40 | |
| | Pigment Dispersion 3 | | | | | | | |
| | Comparative | | | | | | | 40 |
| | Pigment Dispersion 4 | | | | | | | |
| Copolymer | Copolymer 1 | 0.5 | 2 | 5 | 10 | 2 | 2 | 2 |
| Water-soluble | 1,3-butanediol | 15 | 15 | 15 | 15 | 15 | 15 | 15 |
| solvents | Glycerin | 20 | 20 | 20 | 20 | 20 | 20 | 20 |
| | 2-ethyl-1,3-hexanediol | 1 | 1 | 1 | 1 | 2 | 2 | 2 |
| | 2,2,4-trimethyl-1,3-pentanediol | 1 | 1 | 1 | 1 | 0 | 0 | 0 |
| Surfactants | FS-300 | 2.5 | 2.5 | 2.5 | 2.5 | 2.5 | 2.5 | 2.5 |
| | KF-643 | 0 | 0 | 0 | 0 | 1 | 1 | 1 |
| Water-soluble | Polyurethane | 0 | 0 | 0 | 0 | 0 | 0 | 0 |
| resins | emulsion | | | | | | | |
| Pure water | Pure water | 10 | 8.5 | 5.5 | 0.5 | 17.5 | 17.5 | 17.5 |

| | | | | | | | |
|---|---|---|---|---|---|---|---|
| Total | 100 | 100 | 100 | 100 | 100 | 100 | 100 |

TABLE 7

| | | Comp. | Comp. | Comp. | Comp. | Comp. | Comp. |
|---|---|---|---|---|---|---|---|
| | | Ex. 1 | Ex. 2 | Ex. 3 | Ex. 4 | Ex. 5 | Ex. 6 |
| Pigment | Comparative | 50 | | | | | |
| Dispersions | Pigment Dispersion 1 | | | | | | |
| | Comparative | | 40 | | | | |
| | Pigment Dispersion 2 | | | | | | |
| | Comparative | | | 40 | | | |
| | Pigment Dispersion 3 | | | | | | |
| | Comparative | | | | 40 | | |
| | Pigment Dispersion 4 | | | | | | |
| | Comparative | | | | | 50 | |
| | Pigment Dispersion 5 | | | | | | |
| | Comparative | | | | | | 50 |
| | Pigment Dispersion 6 | | | | | | |
| Water-soluble | 1,3-butanediol | 15 | 15 | 15 | 15 | 15 | 15 |
| solvents | Glycerin | 20 | 20 | 20 | 20 | 20 | 20 |
| | 2-ethyl-1,3-hexanediol | 1 | 2 | 2 | 2 | 1 | 1 |
| | 2,2,4-trimethyl-1,3-pentanediol | 1 | 0 | 0 | 0 | 1 | 1 |
| Surfactants | FS-300 | 2.5 | 2.5 | 2.5 | 2.5 | 2.5 | 2.5 |
| | KF-643 | 0 | 1 | 1 | 1 | 0 | 0 |
| Water-soluble | Polyurethane | 0 | 0 | 0 | 0 | 0 | 0 |
| resins | emulsion | | | | | | |
| Pure water | Pure water | 10.5 | 19.5 | 19.5 | 19.5 | 10.5 | 10.5 |

| | | | | | | |
|---|---|---|---|---|---|---|
| Total | 100 | 100 | 100 | 100 | 100 | 100 |

Next, according to the following evaluation criteria, each of the inkjet inks of Examples 1 to 49 and Comparative Examples 1 to 49 was evaluated. The results are shown in the following Tables 8-1, 8-2, and 8-3.

### <Image Density>

A prepared ink was filled in an inkjet printer (IPSIO GX5000, product of Ricoh Company, Ltd.) in an environment of 23° C. and 50% RH. A chart including a 64-point general symbol according to JIS X 0208 (1997), 2223 using Microsoft Word 2000 (product of Microsoft) was printed on MYPAPER (product of Ricoh Company, Ltd.,), and each of the colors of the general symbols on a print face was measured by X-RITE 938, and the results were measured in accordance with the following evaluation criteria.

Note that, the general symbol according to JIS X 0208 (1997), 2223 is a square shaped symbol inside of which is entirely painted with an ink. A printing mode of the inkjet printer was changed to “No Color-Correction” from “Plain Paper-Normal High Speed” by using a printer driver attached to the printer by a user setting of plain paper.

### [Evaluation Criteria]

AA: Black: 1.25 or more
   Magenta: 1.00 or more
   Cyan: 1.00 or more
   Yellow: 0.85 or more
A: Black: 1.20 or more but less than 1.25
   Magenta: 0.95 or more but less than 1.00
   Cyan: 0.95 or more but less than 1.00
   Yellow: 0.80 or more but less than 0.85
B: Black: 1.15 or more but less than 1.20
   Magenta: 0.90 or more but less than 0.95
   Cyan: 0.90 or more but less than 0.95
   Yellow: 0.75 or more but less than 0.80
C: Black: 1.10 or more but less than 1.15
   Magenta: 0.85 or more but less than 0.90
   Cyan: 0.85 or more but less than 0.90
   Yellow: 0.70 or more but less than 0.75
D: Black: less than 1.10
   Magenta: less than 0.85
   Cyan: less than 0.85
   Yellow: less than 0.70

### <Ink Storage Stability>

Each of inks was filled in an ink cartridge and stored at 60° C. for two weeks. A viscosity of change after storage was evaluated to a viscosity before storage in accordance with the following criteria. The viscosity was measured by means of a rotational viscometer (RE500L-type viscometer-cone plate type, product of Toki Sangyo Co., Ltd). Specific operations are shown as follows. The ink (1.1 mL) was sampled and putted into a sample cup of the viscometer. The sample cup was installed in a body of the viscometer and the body was left to stand. Then, a rotor of the viscometer was rotated and a value was read after one minute. A rotation speed was adjusted in accordance with each of the samples.

### [Evaluation Criteria]

AA: Rate of change in viscosity was less than ±3%.
A: Rate of change in viscosity was ±3% or more but less than ±6%.
B: Rate of change in viscosity was ±6% or more but less than ±10%.
C: Rate of change in viscosity was ±10% or more but less than ±20%.
D: Rate of change in viscosity was 20% or more.

### <Ink Ejection Stability>

In ejection stability, after matter had been printed, a printer was left to stand at 50° C. for a month with a printer head capped. In accordance with the following evaluation criteria, evaluated was whether an ejection status recovered to an initial election status or not by the following cleaning times.

### [Evaluation Criteria]

AA: Able to print without cleaning.
A: Recovered by cleaning for 1 to 3 time(s).
B: Recovered by cleaning for 4 to 5 times.
C: Recovered by cleaning for 6 to 10 times.
D: Unable to recover by cleaning for more than 10 times.

TABLE 8-1

| | Image density | Storage stability | Ejection stability |
|---|---|---|---|
| Example 1 | AA | AA | A |
| Example 2 | AA | AA | A |
| Example 3 | AA | AA | A |
| Example 4 | AA | AA | A |
| Example 5 | AA | AA | A |
| Example 6 | AA | AA | A |
| Example 7 | AA | AA | A |
| Example 8 | AA | AA | A |
| Example 9 | AA | A | A |
| Example 10 | AA | AA | A |
| Example 11 | AA | A | A |
| Example 12 | AA | A | A |
| Example 13 | AA | A | A |
| Example 14 | A | A | A |
| Example 15 | AA | A | A |
| Example 16 | AA | AA | A |
| Example 17 | AA | AA | A |
| Example 18 | AA | AA | AA |
| Example 19 | AA | AA | AA |
| Example 20 | AA | AA | A |
| Example 21 | AA | AA | A |
| Example 22 | AA | AA | A |
| Example 23 | AA | AA | A |
| Example 24 | AA | AA | A |
| Example 25 | AA | A | A |
| Example 26 | AA | A | A |
| Example 27 | B | A | A |
| Example 28 | A | A | B |
| Example 29 | A | A | B |
| Example 30 | A | B | B |
| Example 31 | B | A | A |
| Example 32 | A | B | B |
| Example 33 | A | B | B |
| Example 34 | B | B | B |
| Example 35 | B | B | A |
| Example 36 | B | B | B |
| Example 37 | B | B | B |
| Example 38 | B | B | B |
| Example 39 | A | C | C |
| Example 40 | AA | AA | B |
| Example 41 | AA | AA | A |
| Example 42 | AA | AA | A |

TABLE 8-2

| | Image density | Storage stability | Ejection stability |
|---|---|---|---|
| Example 43 | B | A | B |
| Example 44 | A | A | B |
| Example 45 | A | A | B |
| Example 46 | A | A | B |
| Example 47 | A | A | B |
| Example 48 | A | A | B |
| Example 49 | A | B | B |

TABLE 8-3

| | Image density | Storage stability | Ejection stability |
|---|---|---|---|
| Comparative | D | D | D |
| Example 1 | | | |
| Comparative | D | D | D |
| Example 2 | | | |
| Comparative | D | D | D |
| Example 3 | | | |
| Comparative | D | D | D |
| Example 4 | | | |
| Comparative | B | D | D |
| Example 5 | | | |
| Comparative | D | A | D |
| Example 6 | | | |

As can be seen from the above evaluation criteria, all of image density, ink storage stability, and ink ejection stability are excellent in the ink of the present invention which contains the copolymer having the structural units of represented by the General Formula (1) and the General Formula (2) as an ink formulation, and problematic properties can not be found for practical use.

Comparison of Examples 1 to 49 with Comparative Examples 1 to 6 indicates that the ink of the present invention has higher image density, and storage stability and ejection stability are comparable or better.

Moreover, the following can be seen when comparing with one another Examples.

Comparison of Example 1 with Example 9 indicates that the effects are obtained even when neutralization rates of the General Formula (1) are different.

Comparison of Example 1 and Examples 5 to 8 with Examples 20 to 24 indicates that the effects are obtained even when R1 of the General Formula (1) is a methyl group or a hydrogen atom.

Comparison of Example 1 with Example 10 indicates that the effects are obtained even when R2 of the General Formula (2) is a methyl group or a hydrogen atom.

Results of Example 1 and Examples 16 to 19 indicate that the effects are obtained regardless of the kind of neutralized salts. Organic amines are more excellent than alkaline metal salts from the viewpoint of ejection stability.

Comparison of Example 1 with Examples 11 to 15 indicate the effects are obtained even when R6, n, and m of the General Formula (2). In particular, excellent effects are obtained when R6 is a methyl group, n is 9, and m is 0.

Results of Examples 27 to 30 indicate that the effects are obtained regardless of ratios of the General Formula (1) to the General Formula (2).

Comparison of Examples 1 to 26 and Examples 31 to 34 indicates that all of image density, storage stability, and ejection stability are excellent when a viscosity of an aqueous solution phosphoric acid group-containing copolymer having a solid content of 10% by mass is 2.0 mPa·s to 30.0 mPa·s.

Comparison of Examples 31 to 34 with Examples 35 to 38 indicates that all of image density, storage stability, and ejection stability are excellent when the ratios of the General Formula (1) are 10% by mass to 60% by mass.

Comparison of Examples 1, 6 to 8, and 20 with Examples 22 to 24 indicates that the effects are obtained regardless of the formulations of the inks.

Comparison of Examples 1, 5, 20, 21, and Examples 40 to 42 indicates that the effects are obtained regardless of color of pigment.

Comparison of Examples 1, 19, 29 with Examples 40, 41, and 42 indicates that ejection stability is excellent when glycerin is included in the ink.

In an inkjet recording ink of the present invention, each of the color inks has clearly excellent image density and ink storage stability is equal or higher due to an aggregating effect which is caused by reaction with a calcium ion.

That is, the ink of the present invention provides good ink storage stability, good dry property, high image density in plain paper and coated paper for printing, and can be applied to various recordings by an inkjet recording method. An ink recorded matter of the present invention has high image quality, has no bleeding, is excellent in stability over time, and can be suitably used in various applications, for example, as material on which characters or images are recorded. An inkjet recording device with the inkjet recording method can be applied to an inkjet recording printer, a facsimile, a photocopier, and a multifunction peripheral (printer-fax-copier).

Aspects of the present invention are, for example, as follows.

<1> An inkjet recording ink, including:

water;

a water-soluble solvent;

a pigment; and

a phosphoric acid group-containing copolymer,

wherein the phosphoric acid group-containing copolymer contains at least a structural unit represented by the following General Formula (1) and a structural unit represented by the following General Formula (2):

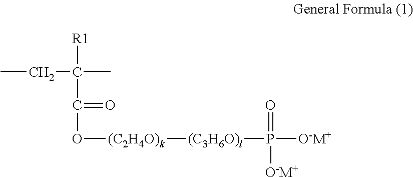

where in General Formula (1), R1 represents a hydrogen atom or a methyl group, M⁺ represents a proton, an alkali metal ion, or an organic ammonium ion, k and l are each an integer of 0 to 6, with the proviso that the case where k and l are 0 at the same time is excluded,

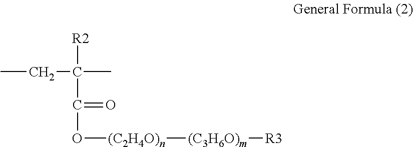

where in General Formula (2), R2 represents a hydrogen atom or a methyl group, R3 represents an alkyl group having 1 to 4 carbon atoms, n and m are each an integer of 0 to 30, with the proviso that n+m is 2 to 30.

<2> The inkjet recording ink according to <1>, wherein an amount of the structural unit represented by the General Formula (1) in the phosphoric acid group-containing copolymer is 10% by mass to 60% by mass.

<3> The inkjet recording ink according to <1> or <2>, wherein a viscosity of an aqueous solution of the phosphoric acid group-containing copolymer having a solid content of 10% by mass is 2.0 mPa·s to 30.0 mPa·s.

<4> The inkjet recording ink according to any one of <1> to <3>, wherein k is 1 and l is 0 in the structural unit represented by the General Formula (1) in the phosphoric acid group-containing copolymer.

<5> The inkjet recording ink according to any one of <1> to <4>, wherein n is 9 and m is 0 in the structural unit represented by the General Formula (2) in the phosphoric acid group-containing copolymer.

<6> The inkjet recording ink according to any one of <1> to <5>, wherein M⁺ is the organic ammonium ion in the structural unit represented by the General Formula (1) in the phosphoric acid group-containing copolymer.

<7> An inkjet recording ink, including:

water;

a water-soluble solvent;

a pigment; and

a phosphoric acid group-containing copolymer,

wherein the phosphoric acid group-containing copolymer is synthesized from starting materials including at least two kinds of monomers which are a monomer represented by the following General Formula (3) and a monomer represented by the following General Formula (4):

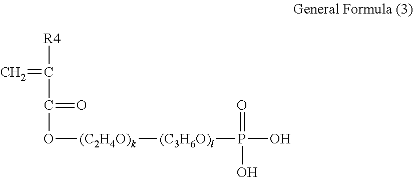

where in Formula (3), R4 represents a hydrogen atom or a methyl group, k and l are each an integer of 0 to 6, with the proviso that the case where k and l are 0 at the same time is excluded,

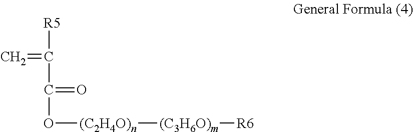

where in Formula (4), R5 represents a hydrogen atom or a methyl group, R6 represents an alkyl group having 1 to 4 carbon atoms, and n and m are each an integer of 0 to 30, with the proviso that n+m is 2 to 30.

<8> The inkjet recording ink according to any one of <1> to <7>, wherein the inkjet recording ink includes glycerin as the water-soluble solvent.

<9> The inkjet recording ink according to any one of <1> to <8>, wherein the phosphoric acid group-containing copolymer serves as a dispersing agent.

<10> An ink cartridge, including:

the inkjet recording ink according to any one of <1> to <9>, and

a container, which houses the inkjet recording ink.

<11> A method for producing an inkjet recorded matter, the method including:

applying a stimulus to the inkjet recording ink according to any one of <1> to <9> by means of an ink jetting unit to allow the ink to jet from a recording head, to thereby record an image on a recording medium.

<12> An inkjet recording device, including:

an ink jetting unit configured to apply a stimulus to the inkjet recording ink according to any one of <1> to <9> to allow the inkjet ink to jet from a recording head, to thereby record an image on a recording medium.

<13> An inkjet recorded matter, including:

an image formed with the inkjet recording ink according to any one of <1> to <9>; and

a recording medium, on which the image is recorded.

This application claims priority to Japanese application No. 2013-226905, filed on Oct. 31, 2013 and incorporated herein by reference.

What is claimed is:

1. An inkjet recording ink, comprising:
water;
a water-soluble solvent;
a pigment; and
a phosphoric acid group-containing copolymer,
wherein the phosphoric acid group-containing copolymer comprises a structural unit represented by the following General Formula (1) and a structural unit represented by the following General Formula (2): 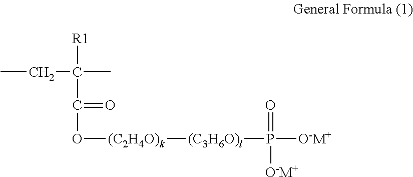
where in General Formula (1), R1 represents a hydrogen atom or a methyl group, M⁺ represents a proton, an alkali metal ion, or an organic ammonium ion, k and l are each an integer of 0 to 6, with the proviso that the case where k and l are 0 at the same time is excluded, 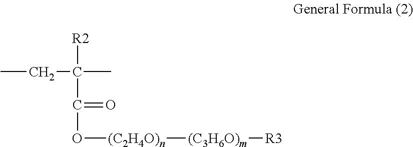
where in General Formula (2), R2 represents a hydrogen atom or a methyl group, R3 represents an alkyl group having 1 to 4 carbon atoms, n and m are each an integer of 0 to 30, with the proviso that n+m is 2 to 30.

2. The inkjet recording ink according to claim 1, wherein an amount of the structural unit represented by the General Formula (1) in the phosphoric acid group-containing copolymer is 10% by mass to 60% by mass.

3. The inkjet recording ink according to claim 1, wherein a viscosity of an aqueous solution of the phosphoric acid group-containing copolymer having a solid content of 10% by mass is 2.0 mPa·s to 30.0 mPa·s.

4. The inkjet recording ink according to claim 1, wherein k is 1 and l is 0 in the structural unit represented by the General Formula (1) in the phosphoric acid group-containing copolymer.

5. The inkjet recording ink according to claim 1, wherein n is 9 and m is 0 in the structural unit represented by the General Formula (2) in the phosphoric acid group-containing copolymer.

6. The inkjet recording ink according to claim 1, wherein M⁺ is the organic ammonium ion in the structural unit represented by the General Formula (1) in the phosphoric acid group-containing copolymer.

7. The inkjet recording ink according to claim 1, wherein the phosphoric acid group-containing copolymer is synthesized from starting materials including at least two kinds of monomers which are a monomer represented by the following General Formula (3) and a monomer represented by the following General Formula (4): 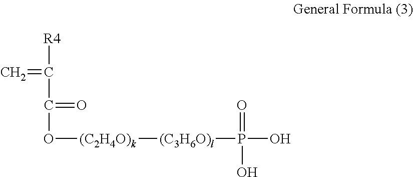
where in Formula (3), R4 represents a hydrogen atom or a methyl group, k and l are each an integer of 0 to 6, with the proviso that the case where k and l are 0 at the same time is excluded, 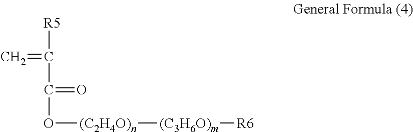
where in Formula (4), R5 represents a hydrogen atom or a methyl group, R6 represents an alkyl group having 1 to 4 carbon atoms, and n and m are each an integer of 0 to 30, with the proviso that n+m is 2 to 30.

8. The inkjet recording ink according to claim 1, wherein the inkjet recording ink comprises glycerin as the water-soluble solvent.

9. The inkjet recording ink according to claim 1, wherein the phosphoric acid group-containing copolymer serves as a dispersing agent.

10. An ink cartridge, comprising:
an inkjet recording ink, and
a container, which houses the inkjet recording ink,
wherein the inkjet recording ink comprises;
water;
a water-soluble solvent;
a pigment; and
a phosphoric acid group-containing copolymer,
wherein the phosphoric acid group-containing copolymer comprises a structural unit represented by the following General Formula (1) and a structural unit represented by the following General Formula (2); 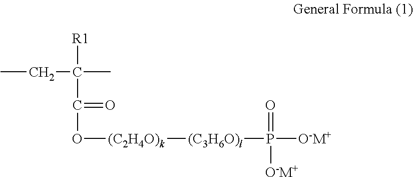
where in General Formula (1), R1 represents a hydrogen atom or a methyl group, M⁺ represents a proton, an alkali metal ion, or an organic ammonium ion, k and l are each an integer of 0 to 6, with the proviso that the case where k and l are 0 at the same time is excluded, 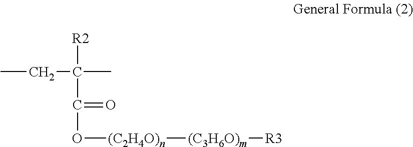
is where in General Formula (2), R2 represents a hydrogen atom or a methyl group, R3 represents an alkyl group having 1 to 4 carbon atoms, n and m are each an integer of 0 to 30, with the proviso that n+m is 2 to 30.

11. An inkjet recording device, comprising:
an ink jetting unit configured to allow an inkjet recording ink to jet from a recording head, to thereby record an image on a recording medium,
wherein the inkjet recording ink comprises:
water;
a water-soluble solvent;
a pigment; and
a phosphoric acid group-containing copolymer,
wherein the phosphoric acid group-containing copolymer comprises a structural unit represented by the following General Formula (1) and a structural unit represented by the following General Formula (2): 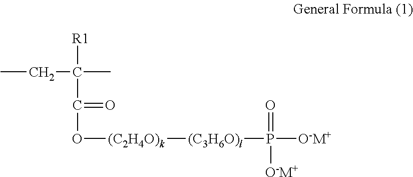
where in General Formula (1), R1 represents a hydrogen atom or a methyl group, M⁺ represents a proton, an alkali metal ion, or an organic ammonium ion, k and l are each an integer of 0 to 6, with the proviso that the case where k and l are 0 at the same time is excluded, 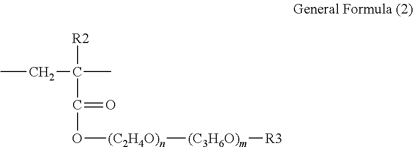
where in General Formula (2), R2 represents a hydrogen atom or a methyl group, R3 represents an alkyl group having 1 to 4 carbon atoms, n and m are each an integer of 0 to 30, with the proviso that n+m is 2 to 30.
